(19) United States
(12) Patent Application Publication
(10) Pub. No.: US 2025/0356192 A1
(43) Pub. Date: Nov. 20, 2025

(54) Efficient Analog Backpropagation Training Architecture for Photonic Neural Network

(71) Applicant: The Board of Trustees of the Leland Stanford Junior University, Stanford, CA (US)

(72) Inventors: Sunil K. Pai, San Jose, CA (US); David A. B. Miller, Stanford, CA (US); Olav Solgaard, Stanford, CA (US); Shanhui Fan, Stanford, CA (US); Tyler William Hughes, San Francisco, CA (US); Ian A.D. Williamson, Palo Alto, CA (US); Momchil Minkov, San Francisco, CA (US); Zhanghao Sun, Mountain View, CA (US)

(21) Appl. No.: 18/126,435

(22) Filed: Mar. 25, 2023

Related U.S. Application Data
(60) Provisional application No. 63/323,743, filed on Mar. 25, 2022.

(51) Int. Cl. G06N 3/084; G06N 3/067

(52) U.S. Cl. CPC G06N 3/084; G06N 3/0675

(57) ABSTRACT

An all-analog optical neural network includes multiple all-analog optical neural network layers; a laser and splitter configured to distribute light signals from the laser equally across all of the multiple all-analog optical neural network layers; integrated MZI switches configured to switch the all-analog optical neural network to a hybrid backpropagation training configuration that measures the light signals in forward and backward directions, and a trains a linear portion of the all-analog optical neural network. Preferably, each of the all-analog optical neural networks comprises: an integrated silicon photonic neural network (PNN) of Mach-Zehnder interferometers (MZIs) and programmable phase shifters (η) configured to implement a programmable unitary matrix-vector multiplication (MVM) operation U; photonic meshes configured to send input forward and backward inference signals to the PNN and configured to measure using both amplitude and phase detection an output forward signal and a backward adjoint signal from the PNN.

### CROSS-REFERENCE TO RELATED APPLICATIONS

This application claims priority from U.S. Provisional Patent Application 63/323,743 filed Mar. 25, 2022, which is incorporated herein by reference.

### STATEMENT REGARDING FEDERALLY SPONSORED RESEARCH OR DEVELOPMENT

This invention was made with Government support under contract FA9550-18-1-0186 and FA9550-17-1-0002 awarded by the Air Force Office of Scientific Research. The Government has certain rights in the invention.

### FIELD OF THE INVENTION

The present invention relates generally to hybrid photonic neural networks. More specifically, it relates to backpropagation training architectures and techniques for hybrid photonic neural networks.

### BACKGROUND OF THE INVENTION

Neural networks (NNs) are ubiquitous computing models loosely inspired by the structure of a biological brain. Such models are trained on input data to implement complex signal processing or “inference”, powering various modern technologies ranging from language translation to self-driving cars. The required energy for training and inference to power these technologies has recently been estimated to double every 5 to 6 months, and thus necessitates an energy-efficient hardware implementation for NNs.

To address this problem, programmable photonic neural networks (PNNs) have been proposed as a promising, scalable, and mass-manufacturable integrated photonic hardware solution. A popular implementation of PNNs uses silicon photonic meshes, N×N networks of Mach-Zehnder interferometers (MZIs) and programmable phase shifters, which optically accelerate the most expensive operation in a PNN: unitary matrix-vector multiplication (MVM). The MVM y=Ux is implemented by simply sending an input mode vector x (optical phases and modes in N input waveguides) through the network implementing U to yield output modes y. This fundamental mathematical operation, based on optical scattering theory, additionally enables various analog signal processing applications beyond machine learning such as telecommunications, quantum computing, and sensing.

Recently, “hybrid” PNNs, which interleave programmable photonic linear optical elements (e.g., meshes) and digital nonlinear activation functions, have proven to be a low-latency and energy-efficient solution for NN inference in circuit sizes of up to N=64.

Compared to current fully analog PNNs with electrooptic (EO) nonlinear activations, hybrid PNNs get around the critical problem of photonic loss and offer more versatility than multilayer PNNs for between-layer logical operations that do not favor optics. Such features may be present in a number of state-of-the-art machine learning architectures such as recurrent neural networks and transformers. When fully optimized, the energy efficiency of PNN inference has been estimated to be up to two orders of magnitude higher than state-of-the-art digital electronic application specific integrated circuits (ASICs) in AI. However, despite the success in PNN-based inference, on-chip training of PNNs has not been demonstrated due to various challenges including significantly higher experimental complexity compared to the inference procedure.

### BRIEF SUMMARY OF THE INVENTION

Machine learning tasks can be more efficiently solved by applying the widely used backpropagation algorithm, the most widely used machine learning algorithm, to hybrid photonic neural networks that are significantly more time- and energy-efficient compared to current digital alternatives.

Herein we disclose techniques for a new analog in situ backpropagation method and architecture for measuring gradients to ultimately improve the energy efficiency of training any hybrid photonic neural network using in-mesh optical monitoring.

Advantages and improvements over existing techniques include the following:
Entirely analog gradient update mechanism avoids unnecessary energy consumption for analog-to-digital conversion and digital subtraction in final gradient step
Bidirectionally operated, fully-monitored photonic circuit unlocks efficient analog gradient measurement
Only linear optical devices require analog gradient measurement
Flexible hybrid architecture: incorporate existing popular automatic differentiation packages such as JAX, Tensorflow and PyTorch with analog gradient measurements

We design and demonstrate an in situ (on-chip) backpropagation training algorithm for photonic neural networks that trains photonic networks of Mach-Zehnder interferometers more efficiently than any current method, using the well-known backpropagation training approach in machine learning. In an example demonstration, the setup includes a 6×6 bidirectional network of Mach-Zehnder interferometers (light can be sent either forwards and backwards), in-mesh monitoring grating taps to measure power at all intermediate points in the photonic circuit imaged by an IR camera, and a computer capable of performing all nonlinearities and computationally inexpensive automatic differentiation. Taken together, this setup is the first of its kind and is demonstrated to be sufficient to implement backpropagation with photonics-accelerated in situ gradient measurement; it is also the first practical proposal of this technique in that we only use the computationally intensive linear portion on the device and leave the rest of the gradient computation to the computer.

We also describe adding a new “backprop unit” capable of summing signals at the “left” forward input of the photonic network for the third step of our method, which allows us to perform an efficient analog gradient computation without ever converting optical measurements to digital values (unlike previous approaches). The idea is to sweep an adjoint global phase modulator from 0 to 2π repeatedly while measuring the difference between the zero-phase value and average (DC) component of the signal. In a commercial implementation, an integrated photodetector-based in-mesh monitors, and analog signal processing using a lock-in amplifier matched to the frequency of the adjoint global phase modulator, would be used to measure gradients. Overall, we have designed an experimental system that proves that in situ backpropagation is a feasible, accurate and efficient training algorithm for photonic neural networks.

Commercial applications of the technique include the following:
Photonic matrix multiply accelerator devices for machine learning/AI-based data centers Adaptive optics and photonics for LIDAR and sensing
Photonic circuit sensitivity analysis
Error correction of photonic circuits

The techniques may be implemented for larger photonic integrated circuits (including up to N=64). The techniques may be implemented using integrated photodetector taps instead of grating taps. The techniques may be implemented using fast input modulators and accurate output phase detectors.

In one aspect, the invention provides an all-analog optical neural network comprising multiple all-analog optical neural network layers; a laser and splitter configured to distribute light signals from the laser equally across all of the multiple all-analog optical neural network layers; integrated MZI switches configured to switch the all-analog optical neural network to a hybrid backpropagation training configuration that measures the light signals in forward and backward directions, and a trains a linear portion of the all-analog optical neural network. In a preferred implementation, each of the all-analog optical neural networks comprises: an integrated silicon photonic neural network (PNN) of Mach-Zehnder interferometers (MZIs) and programmable phase shifters (η) configured to implement a programmable unitary matrix-vector multiplication (MVM) operation U; a first photonic mesh configured to send an input forward inference signal to the PNN and to measure an output backward adjoint signal from the PNN; a second photonic mesh configured to measure an output forward inference signal from the PNN and to send an input backward adjoint signal to the PNN; where the forward inference signal propagates forward through the PNN and backward adjoint signal propagates backward through the PNN; and where the first photonic mesh and the second photonic mesh are configured to implement both amplitude and phase detection.

In another aspect, the invention provides a hybrid optical-electronic neural network circuit comprising: a digital circuit configured to implement a nonlinear activation function; an integrated silicon photonic neural network (PNN) of Mach-Zehnder interferometers (MZIs) and programmable phase shifters (η) configured to implement a programmable unitary matrix-vector multiplication (MVM) operation U; a first photonic mesh configured to send an input forward inference signal to the PNN and to measure an output backward adjoint signal from the PNN; a second photonic mesh configured to measure an output forward inference signal from the PNN and to send an input backward adjoint signal to the PNN; wherein the forward inference signal propagates forward through the PNN and backward adjoint signal propagates backward through the PNN; wherein the first photonic mesh and the second photonic mesh are configured to implement both amplitude and phase detection; one or more lasers configured to send the forward inference signal forward through the PNN and to send the backward adjoint signal backward through the PNN; control circuitry configured to generate the forward inference signal, backward adjoint signal, a sum of forward inference and backward adjoint measurements, and produce a PNN gradient update signal to update the programmable phase shifters of the PNN.

In a preferred implementation, the control circuitry comprises timed switches, sample-and-hold circuits and amplifiers, and is configured to implement the backpropagation on batches of training data by subtracting in the electronic domain a difference of forward and adjoint signals from a sum of forward and adjoint signals.

### BRIEF DESCRIPTION OF THE SEVERAL VIEWS OF THE DRAWINGS

FIG. 1A is a schematic illustration of an example of an unlabelled 2D set of points that are formatted to be input into a photonic neural network.

FIG. 1B is a schematic diagram showing an example photonic neural network used to perform in situ backpropagation training of an L-layer PNN for data input in the forward direction.

FIG. 1C is a schematic diagram showing an example photonic neural network used for data input in the backward direction, showing the dependence of gradient updates for phase shifts on backpropagated errors.

FIG. 1D is a plot of classification results of the inference task implemented on the actual chip.

FIG. 1E details forward, backward, and sum steps of in situ (analog) backpropagation, using a mesh implementing coherent bidirectional unitary matrix-vector products.

FIG. 2A is a photo of a photonic mesh chip that is thermally controlled and wirebonded to a custom PCB with fiber array used in an analog gradient experiment and simulation.

FIG. 2B is a schematic diagram of the photonic mesh chip apparatus shown in FIG. 2A.

FIG. 2C) is a schematic diagram showing an analog gradient update circuit that may might optionally be implemented by introducing a summing interference circuit.

FIG. 2D is a graph illustrating the effect of toggling the adjoint phase to evaluate the analog gradient measurement.

FIG. 2E is a graph of measured and predicted gradient error when the implemented mesh was perturbed.

FIG. 2F is a plot of measured normalized gradient error with respect to cost function.

FIG. 3A is a schematic diagram of a three layer hybrid PNN used in an in situ backpropagation experiment.

FIG. 3B shows a three-step digital subtraction gradient update given monitored waveguide powers and the measured gradient output.

FIG. 3C is a graph of a cost function vs iteration for a circle dataset, comparing digital and in situ backpropagation training curves.

FIG. 3D is a gradient error histogram for the circle dataset.

FIG. 3E is a classification plot for the circle dataset.

FIG. 3F is a graph of a cost function vs iteration for a moons dataset, comparing digital and in situ backpropagation training curves.

FIG. 3G is a gradient error histogram for the moons dataset.

FIG. 3H is a classification plot for the moons dataset.

FIG. 4A is a schematic diagram of a two-layer PNN used in an in situ backpropagation simulation.

FIGS. 4B, 4C are graphs showing marginal training curve statistics in a backpropagation simulation.

FIG. 5A is a grating monitor closeup photograph of an experimental setup showing the bidirectional grating tap used to perform a backpropagation protocol.

FIG. 5B is an image showing metal trace, via, and TiN phase shifter colocated with the grating monitor.

FIG. 5C shows fiber array inputs to the photonic mesh and used for interfacing fiber arrays.

FIG. 5D is a large scale view of a section of a chip used to perform a backpropagation protocol.

FIG. 5E is an image of the experimental setup with a PCB.

FIG. 6A is a schematic diagram of a photonic network showing calibration of 0 internal phase shifts using lightwires leading to MZIs.

FIG. 6B is a schematic diagram of a photonic network showing calibration of ϕ phase shifts using lightwires leading to meta-MZI structures created out of four neighboring MZIs.

FIG. 6C is a graph of camera spot measurement vs square voltage power, showing phase shifter calibration.

FIG. 6D is a graph of camera spot measurement vs square voltage power, illustrating that different grating taps have different coupling efficiencies.

FIG. 6E is a graph of voltage vs phase, showing a linear regime of the calibration curve for phase shifters.

FIG. 7 is a schematic diagram illustrating a three-layer power monitoring profile for digital subtraction, including training curve graph and classification plot.

FIGS. 8A-8J are graphs of in situ backpropagation training results.

FIGS. 8A-8F are graphs of in situ backpropagation training results showing a comparison of the model cost and accuracy curves between circle, moons (measured) and moons (corrected) experiments, comparing test (FIG. 8A-8C) and train (FIG. 8D-8F) data.

FIG. 8G is a graph showing the error in the gradient increases with the batch size.

FIG. 8H is a graph showing the gradient error increases over the course of the optimization.

FIGS. 8I, 8J are plots showing device accuracy for moons and ring dataset inference tasks, respectively, showing the model boundary in the background and device-classified points.

FIG. 9A is a schematic diagram of a triangular MZI network implementing coherent multiplication by a matrix U.

FIG. 9B is a schematic diagram illustrating how a vector unit can be unbalanced or balanced.

FIG. 9C is a schematic diagram showing an architecture for coherent detection or homodyne detection to measure amplitudes and phases.

FIG. 9D is a schematic diagram showing a coherent matmul operation.

FIG. 9E is a schematic diagram showing backward coherent matrix multiplication.

FIG. 9F is a schematic diagram showing how self-configuration proceeds by nullifying ports 5 through 2 in descending order.

FIG. 9G is a schematic diagram showing how nullification is achieved using phase measurement rather than analog feedback minimization.

FIG. 10A is a schematic diagram showing a conceptual analog gradient update flow.

FIG. 10B shows an alternative update method from that shown in FIG. 10A.

FIG. 10C is an image showing an analog update gradient circuit in the optimized version of our protocol in a hypothetical CMOS co-integrated photonic-electronic implementation.

FIG. 10D is a timing diagram for various switches to implement the analog subtraction protocol.

FIG. 10E are graphs of results from a camera-based high-pass analog gradient demonstration.

FIG. 10F is a graph of tap coupling strength vs column.

FIG. 11A is a schematic diagram showing a modified analog backpropagation scheme.

FIG. 11B is an image of a circuit board used in a demonstration of analog backpropagation.

FIG. 11C is a graph of normalized response vs time step comparing measured and predicted analog gradients.

FIG. 11D are graphs of elementwise gradient comparisons.

FIG. 12A is a schematic diagram showing various components considered in a hierarchical analysis of in situ backpropagation energy consumption.

FIG. 12B is a schematic diagram showing the subtasks and final tasks in a hierarchical analysis of in situ backpropagation energy consumption.

FIG. 12C is a graph of MVM energy efficiency with respect to number of modes (N) and batch sizes (M).

FIG. 12D is a graph of VJP/grad energy efficiency with respect to number of modes (N) and batch sizes (M).

FIG. 13A is a schematic diagram showing a two-layer, low-loss all-analog PNN for inference which uses a low-loss electrooptic (EO) nonlinearity.

FIG. 13B illustrates how in situ backpropagation is enabled using a switching architecture between each layer allows measurement of forward-going and backward-going signals for each layer.

FIG. 13C is a schematic diagram showing a configuration designed to detect previous layer FIG. 13D is a schematic diagram showing a configuration designed for EO activation (send to next layer or detect to calibrate).

FIG. 13E is a schematic diagram showing a configuration designed to debug nonlinearity by directly changing the voltage applied to the ring modulator.

FIG. 13F is a schematic diagram showing a configuration designed to measure backward signal coming from the next layer back into the previous layer.

FIG. 13G is a schematic diagram showing a configuration designed to calibrate the input into the current layer without the nonlinearity.

FIG. 13H is a schematic diagram illustrating a comparison of the lossy propagation of typical all-analog PNNs versus low-loss distributed PNNs.

### DETAILED DESCRIPTION OF THE INVENTION

### Introduction

We disclose herein a photonic implementation of backpropagation, the most widely used method of training NNs. Backpropagation is generally performed by propagating error signals backwards through the NNs to determine programmable parameter gradients via the chain rule. In our multilayer PNN device, we performed in situ training on a foundry-manufactured silicon photonic integrated circuit by sending light-encoded errors backwards through the PNN and measuring optical interference with the original forward-going “inference” signal. Once trained, our chip achieved similar accuracy to digital simulations, adding new capabilities beyond existing inference or in silico learning demonstrations. We further designed and experimentally validated an analog (electro-optic) phase shifter update protocol, a key improvement over past proposals requiring more energy-intensive “digital subtraction”. Finally, we systematically analyzed energy and latency advantages of in situ backpropagation and its scalability to larger (64×64) PNN systems. Our findings ultimately pave the way for energy-efficient optoelectronic training of neural networks and optical systems more broadly.

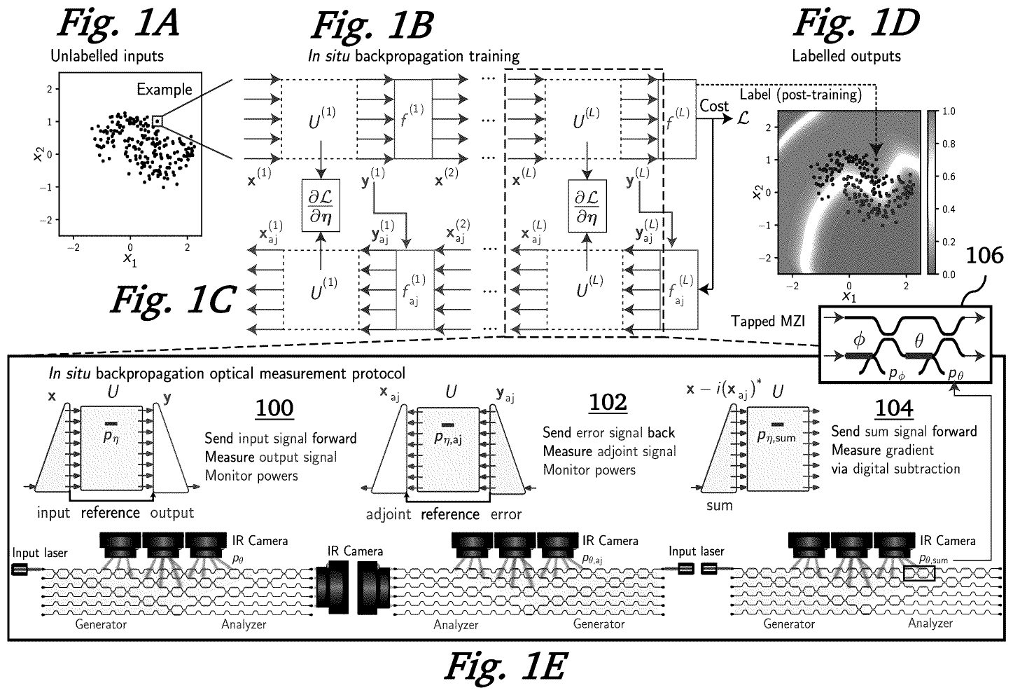

FIGS. 1A-1E are schematic diagrams providing an overview of a in situ backpropagation technique according to an embodiment of the invention. FIG. 1A is a schematic illustration of an example machine learning problem: an unlabelled 2D set of points that are formatted to be input into a PNN. One of the points is input to the PNN as shown in FIG. 1B to perform in situ backpropagation training of an L-layer PNN for the forward direction and input into the PNN as shown in FIG. 1C in the backward direction, showing the dependence of gradient updates for phase shifts on backpropagated errors. FIG. 1D shows results of the inference task implemented on the actual chip which resulted in good agreement between the chip-labelled points and the ideal implemented ring classification boundary (resulting from the ideal model) and a 90% classification accuracy. FIG. 1E illustrates three steps of in situ (analog) backpropagation, using a 6×6 mesh implementing coherent 4×4 bidirectional unitary matrix-vector products using a reference arm. The forward step 100, backward step 102, and sum step 104, of in situ backpropagation are shown. Arbitrary input setting and complete amplitude and phase output measurement were enabled in both directions using the reciprocity and symmetries of the triangular architecture. All powers throughout the mesh were monitored by an IR camera using the tapped MZI 106 for each step, allowing for digital subtraction to compute the gradient. These power measurements performed at phase shifts are indicated by green horizontal bars.

### Photonic Neural Networks

We built a hybrid PNN by alternating sequences of analog programmable unitary MVM operations [symbol] (implemented on a custom designed silicon photonic triangular mesh) and digital nonlinear transformations [symbol] (implemented using autodifferentiation software) where layer [symbol] ≤L (total of L layers). The PNN was parameterized by programmable phase shifts \vec{η}∈[0, 2π)D, where D represents number of PNN phase shifters. Mathematically, the following “inference” function sequence transformed input x=x⁽¹⁾, proceeding in a “feedforward” manner to the output \hat{z}:=x^{(L+1)} (FIG. 1A-1D):

$${y}^{( ℓ )} = {U}^{( ℓ )} {x}^{( ℓ )} \qquad ( 1 )$$

$${x}^{( ℓ + 1 )} = {f}^{( ℓ )} ( {y}^{( ℓ )} ) \qquad ( 2 )$$

The “cost function” is defined as [symbol] (x, z)=c(\hat{z}(x),z), where c represents the error between \hat{z} and ground truth label z. Backpropagaion updates parameters 4 based on D-dimensional gradient ∂ [symbol] /∂\vec{η} evaluated for “training example” (x, z) (or averaged over a batch of examples).

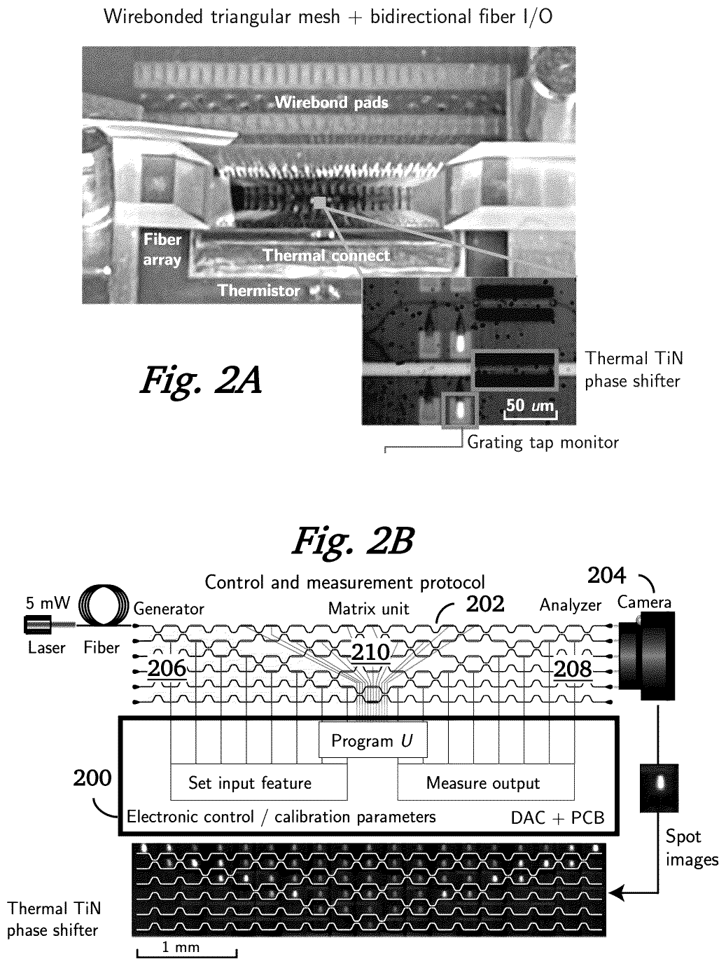

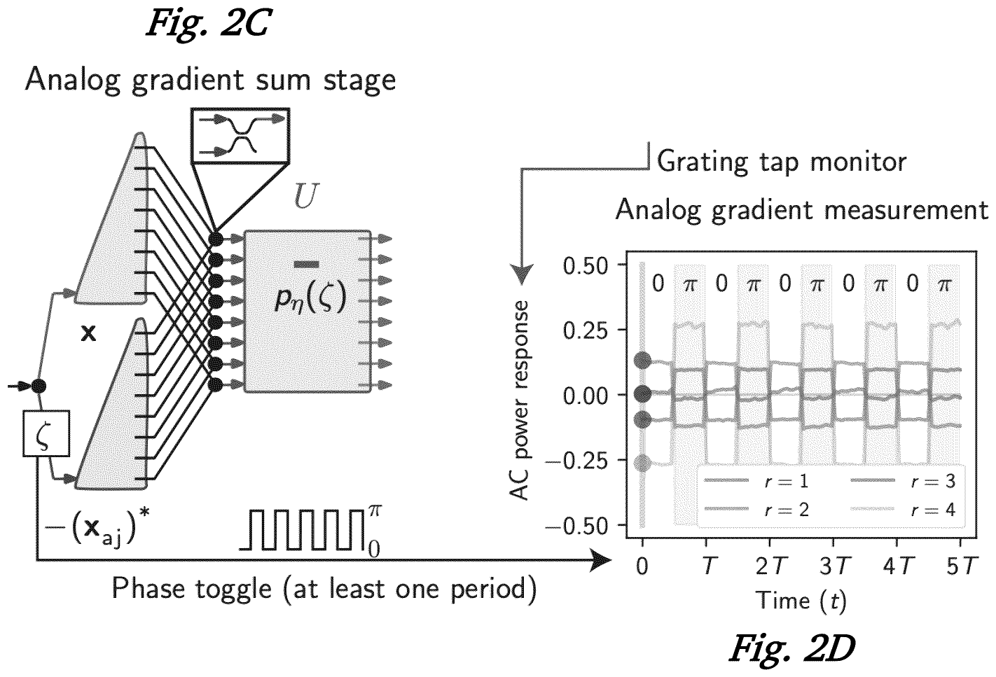

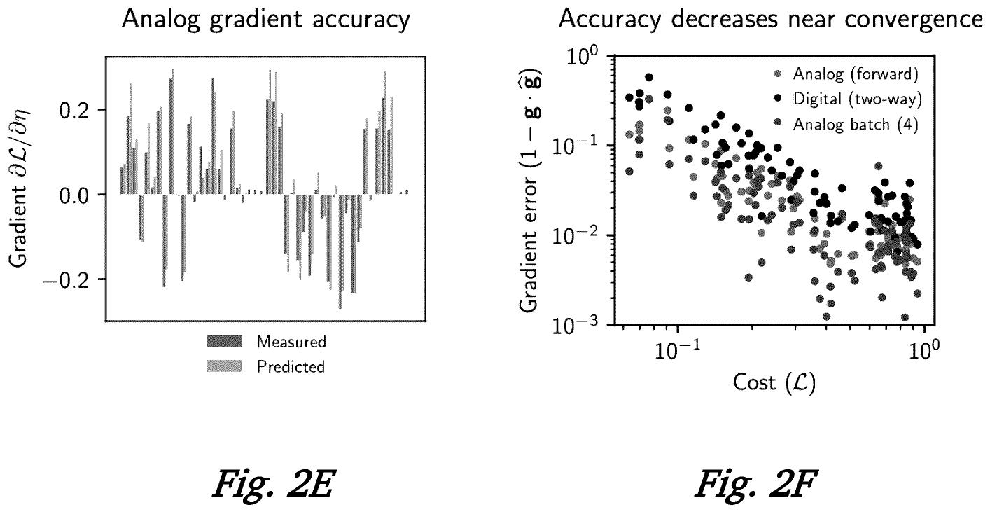

FIGS. 2A-2F illustrate an analog gradient experiment and simulation. As illustrated in the photo of FIG. 2A, the photonic mesh chip was thermally controlled and wirebonded to a custom PCB with fiber array for laser input/output and a camera overhead for imaging the chip. Zooming in reveals the core control-and-measurement unit of the chip, enabling power measurement using 3% grating tap monitors and a thermal TiN phase shifter nearby.

As shown in the schematic diagram of FIG. 2B, a calibrated control unit 200 was used for input generation and output detection to and from the PNN 202 which is composed of generator 206, analyzer 208, and matrix unit 210 optical I/O circuits. The IR camera 204 over the chip imaged all grating tap monitors necessary for backpropagation. FIG. 2C) is a schematic diagram showing an analog gradient update that may might optionally be implemented by introducing a summing interference circuit (not implemented on the chip in FIG. 2B) between the input and adjoint fields. As shown in FIG. 2D, the adjoint phase was toggled between ζ=0 and π to evaluate the analog gradient measurement ∂ [symbol] /∂_{η} for i=1 to 4. As shown in FIG. 2E, gradients measured using the toggle scheme yielded approximately correct gradients when the implemented mesh was perturbed from the optimal (target) unitary given 1 rad phase standard deviation. As shown in FIG. 2F, measured normalized gradient error decreased with cost function (distance between implemented U(j) and optimal U=DFT(4)), and analog batch and single-example gradients outperformed digital gradients.

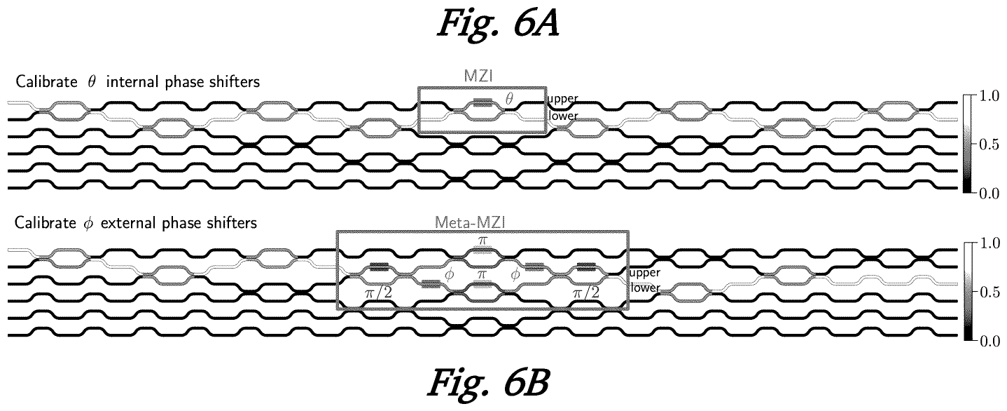

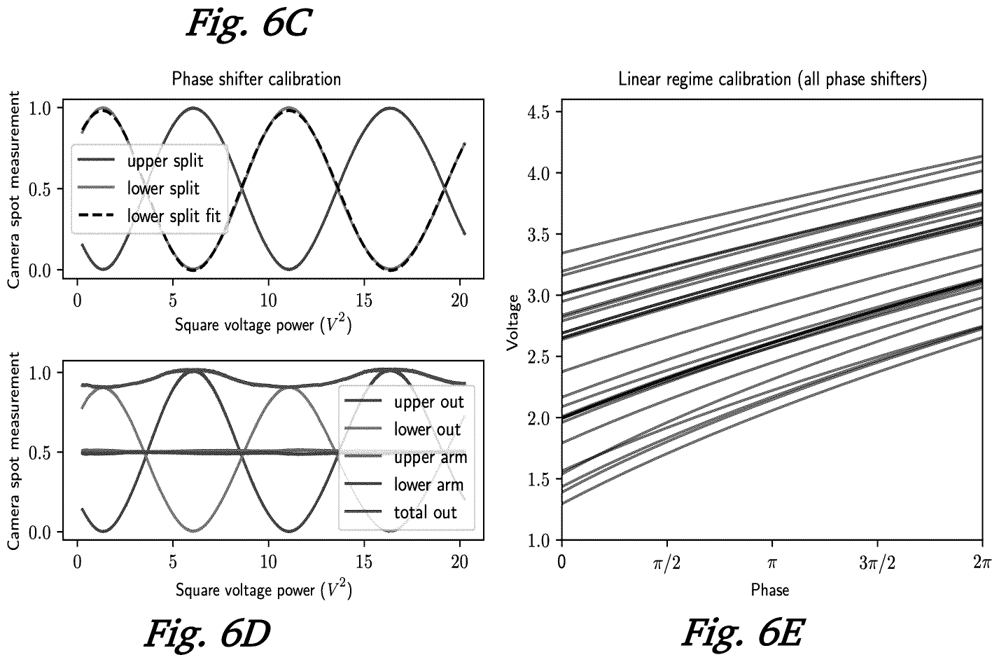

Each MZI in the PNN 202 was parametrized by thermo-optic phase shifters that locally heat the waveguides using current sourced from a separate control driver board. Phase shifts were placed at the input (ϕ, voltage V_{ϕ}) and internal (θ, voltage V_{θ}) arms of all MZIs to control propagation pattern of light enabling arbitrary unitary matrix multiplication. We embedded an arbitrary 4×4 unitary matrix multiply in a 6×6 triangular network of MZIs. This configuration incorporated two 1×5 photonic meshes on either end of the 4×4 “matrix unit” capable of sending any input vector x and measuring any output vector y from Eqs. 1 and 2. These generator 206 and analyzer 208 optical I/O circuits use calibrated voltage mappings θ(V_{θ}), ϕ(V_{ϕ}) to control optical phase (see FIGS. 6A-6E for further details).

### Backpropagation Demonstration

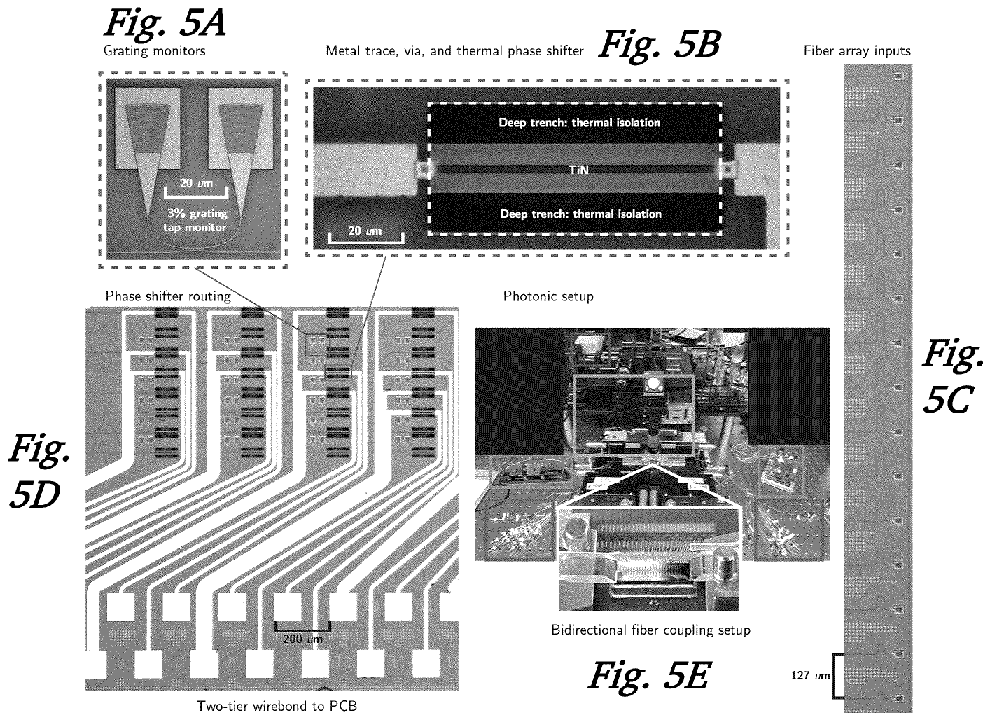

Our core result (FIG. 1E) was experimental realization of backpropagation on a photonic triangular mesh MVM chip using a custom optical rig and silicon photonic chip (FIG. 5).

Our backpropagation-enabled architecture differs in three ways from a typical PNN photonic mesh:
1. We enabled “bidirectional light propagation,” the ability to send and measure light propagating left-to-right or right-to-left through the circuit (as depicted in FIG. 1E).
2. We implemented “global monitoring” to measure optical power p_{η} propagating through any phase shift η in the circuit using 3% grating taps (shown in the inset of FIG. 1E and FIG. 2A-2B). In our proof-of-concept setup, we used an IR camera mounted on an automated stage to image these taps throughout the chip (FIG. 5E).
3. We implemented both amplitude and phase detection (improving on past approaches) using a self-configuring programmable matrix unit layer on both generator and analyzer subcircuits (FIGS. 1E, 2B, 9), which by symmetry worked for sending and measuring light that propagated forward or backward through the mesh.

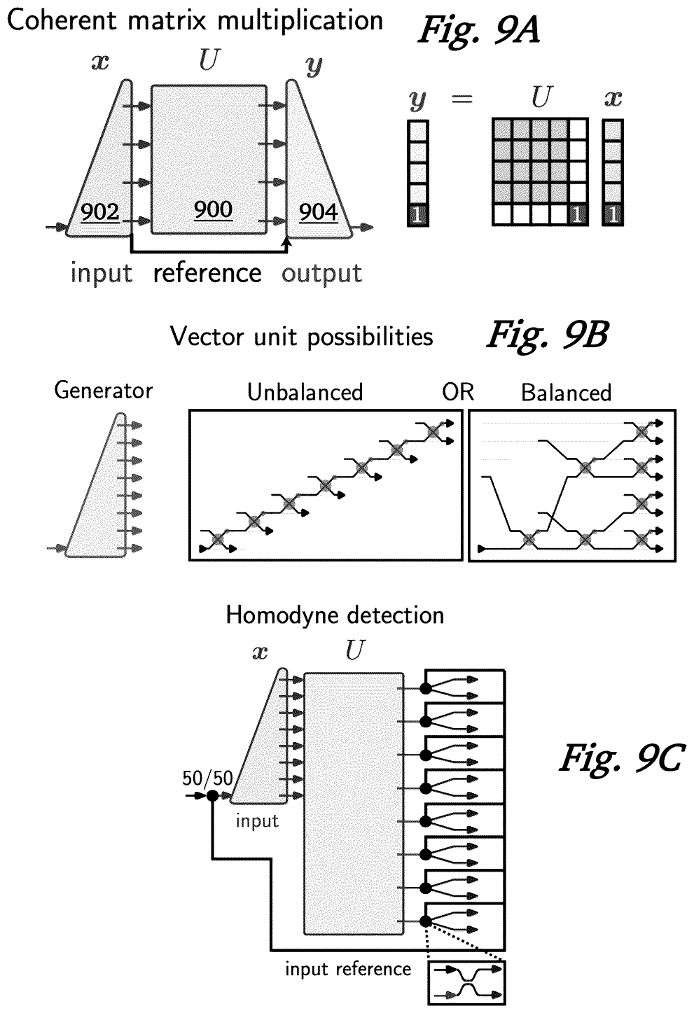

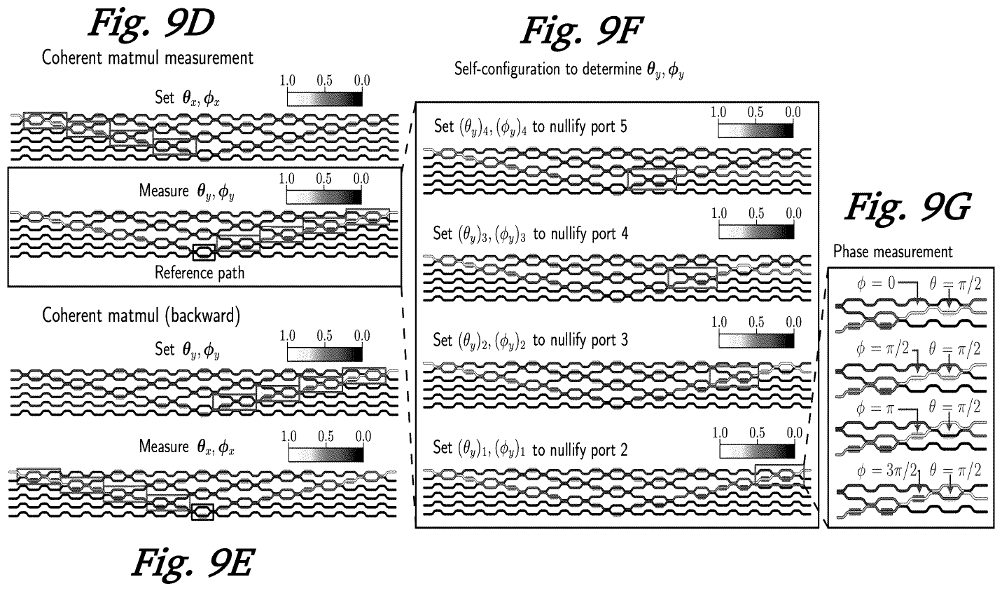

These improvements on an already versatile hardware platform enabled backpropagation entirely using physical optical power measurements to obtain cost gradients. As shown in FIG. 1E, backpropagation uses global optical monitoring, and bidirectional optical I/O was used to switch between forward- and backward-propagating signals to experimentally realize in situ backpropagation. Equipped with these additional elements, our protocol can be implemented on any feedforward photonic circuit with the requisite analyzer and generator circuitry (FIGS. 1A-1E and FIGS. 9A-9G).

Here we give a quick summary of the procedure (further explained below). The “forward inference” signal [symbol] and “backward adjoint” signal

$${x}_{adj}^{( ℓ )}$$

are sent forward and backward respectively through the mesh that implements [symbol] . The “sum” vector

$${x}^{( ℓ )} - {i ( {x}_{adj}^{( ℓ )} )}^{*}$$

is sent forward and subtracting the forward and backward measurements from it digitally yields se gradient, a reverse-mode differentiation process we call an “optical vector-Jacobian product (VJP).”

### Analog Update

We additionally disclose a more energy-efficient fully analog gradient measurement update for the final step avoiding a digital subtraction update. Instead of global monitoring the first two steps and the final “sum” step, we toggled an adjoint phase ζ(t), a square wave modulation with period T that periodically toggles between “sum” and “difference” settings ζ=0 and π corresponding to signal inputs

$${x}_{\pm }^{( ℓ )} = {x}^{( ℓ )} ∓ {i ( {x}_{adj}^{( ℓ )} )}^{*} .$$

The gradient is

∂ [symbol] /∂η=(p_{η}+−p_{η},−)/4,

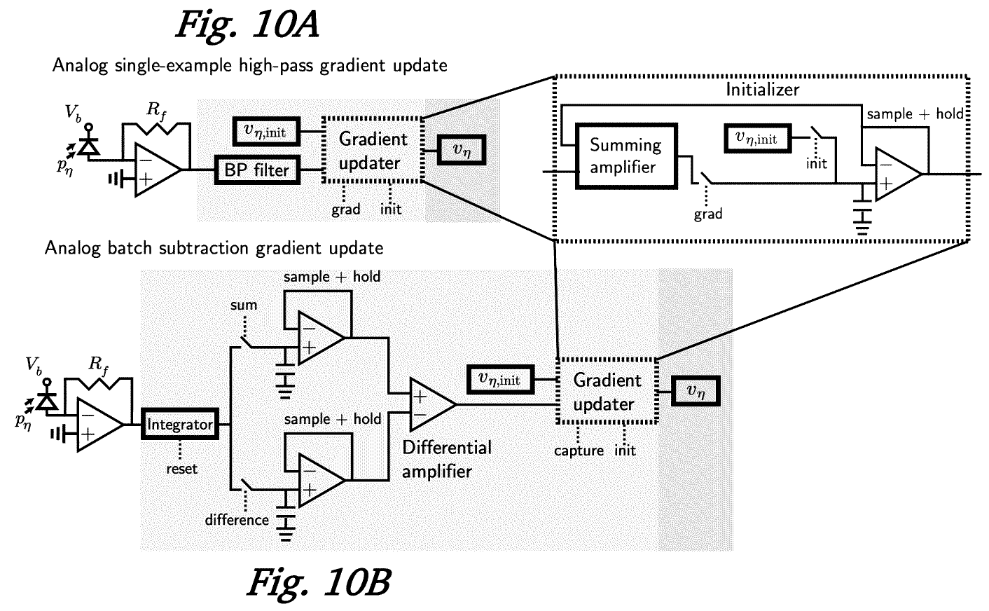

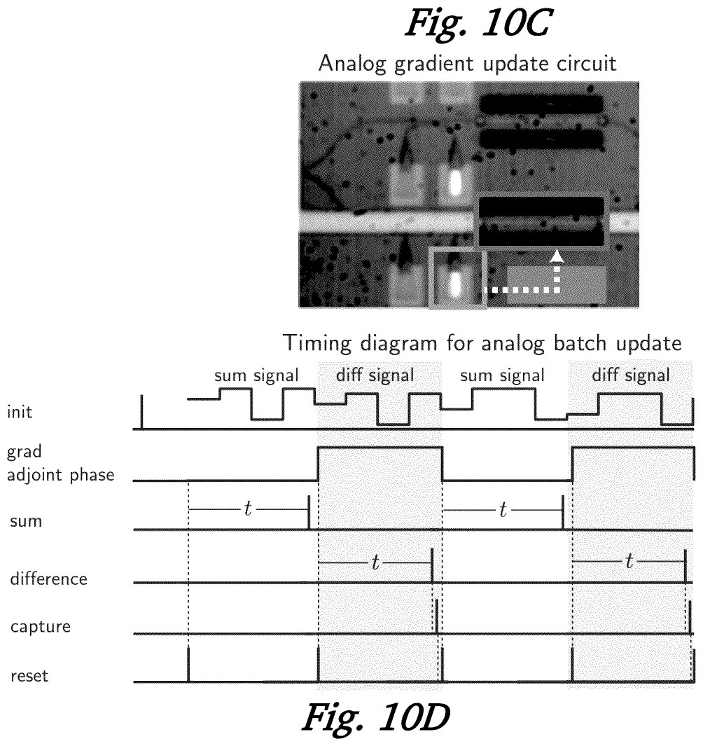

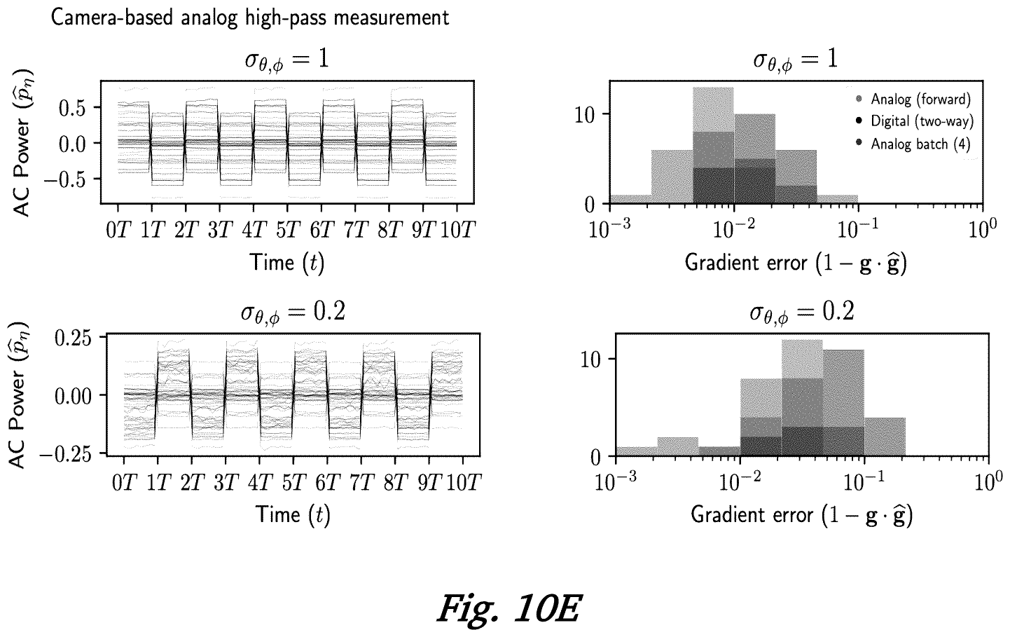

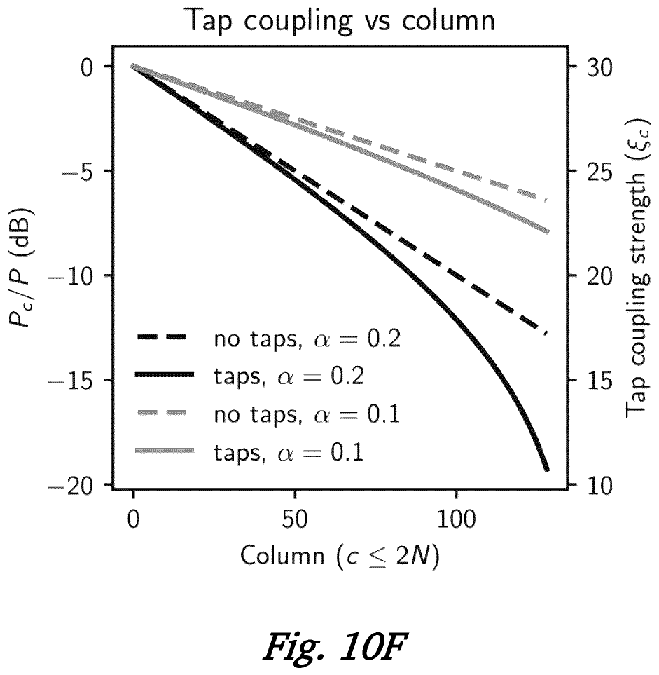

or half the “signed amplitude” of the AC (mean-subtracted) signal (FIGS. 10A-10F). The sum and difference inputs

$${x}_{\pm }^{( ℓ )}$$

were computed digitally (off-chip), requiring [symbol] (N) operations to compute per input. The sum and difference inputs were directly programmed at the generator to compute phase gradients, subtracted in the analog domain to update phase shift voltages. One option to efficiently achieve a periodic ζ toggle is to use the summing architecture in FIG. 2C which sums [symbol] and

$${i ( {x}_{adj}^{( ℓ )} )}^{*}$$

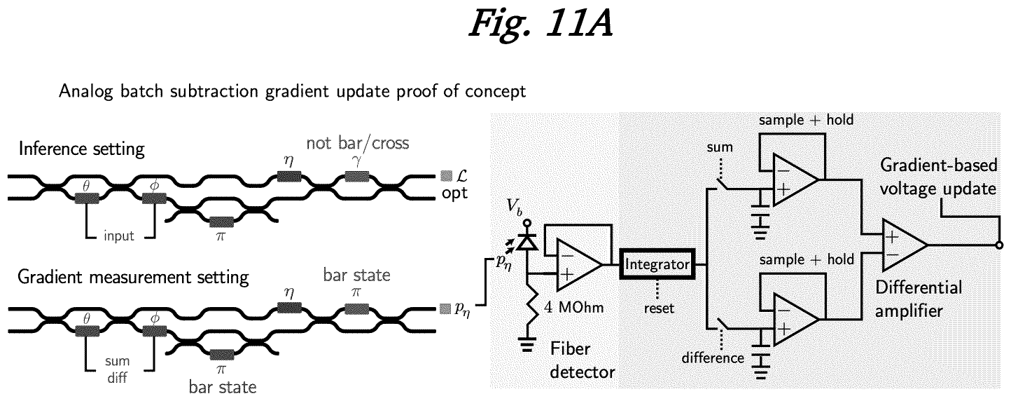

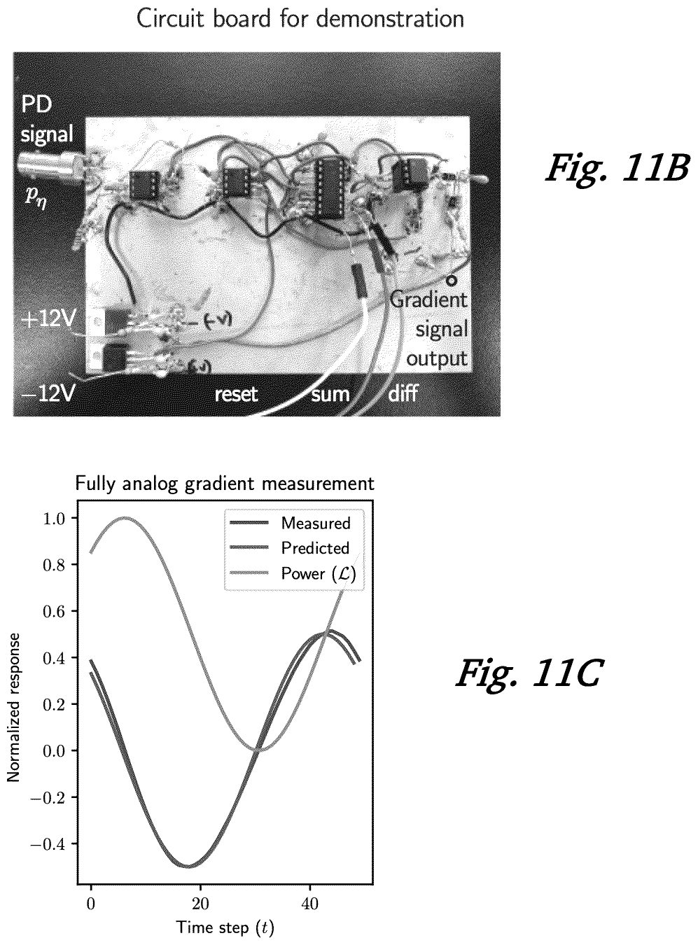

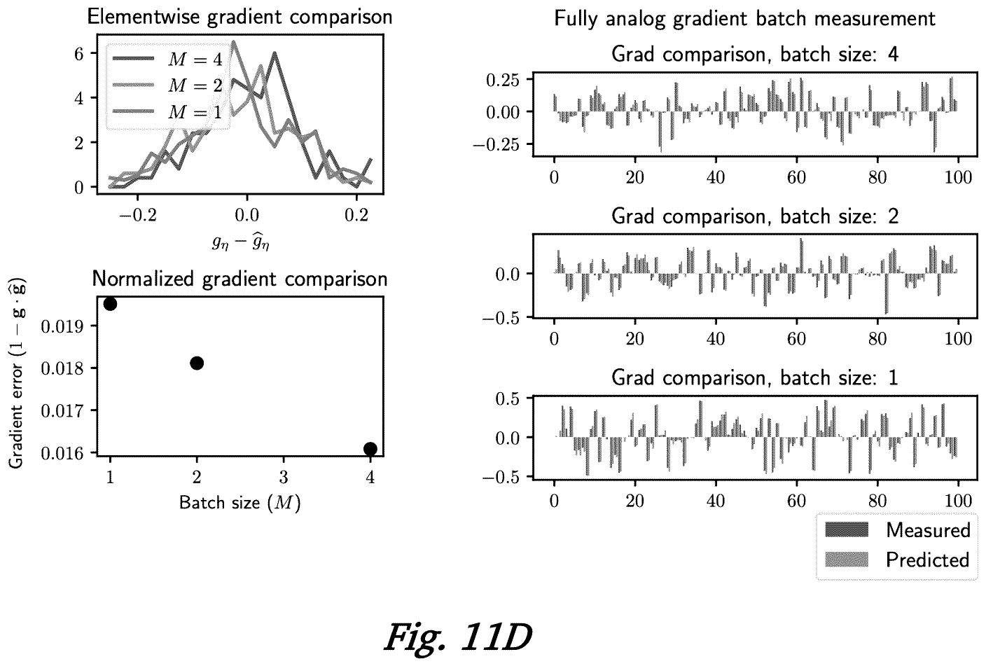

interferometrically with a fast modulator implementing ζ. In an optimized scheme, we would physically measure the gradient and update the phase shift voltage in the analog domain using a photodiode, differential amplifier (implementing an analog subtraction), and a “sample-and-hold” update circuit using only a single toggle (FIG. 10B-10C). This scheme, extended to energy-efficient “batch updates” incorporating data from multiple training examples, was tested on a single phase shifter to demonstrate the logic of this electronic feedback scheme (FIGS. 11A-11D). Our demonstration avoided a costly digital-analog and analog-digital conversion; when fully integrated, our approach avoids additional digital memory complexity required to program N² elements, enabling a truly analog backpropagation scheme.

The local feedback just described updates each phase shifter r, using the measured gradient:

$$\frac{\partial ℒ}{\partial η} = ℐ ( {x}_{η} {x}_{η , adj} ) = \frac{{\vert {x}_{η , +} \vert}^{2} - {\vert {x}_{η} \vert}^{2} - {\vert {x}_{η , adj} \vert}^{2}}{2} = \frac{{p}_{η , +} - {p}_{η} - {p}_{η , adj}}{2} = \frac{{p}_{η , +} - {p}_{η , -}}{4} , \qquad ( 3 )$$

where

$${x}_{η , +} = {x}_{η} - i {x}_{η , adj}^{*}$$

and the last equality of eq. 3 indicates the mathematical equivalence of “digital subtraction,” (FIG. 1E) and our “analog subtraction” scheme (FIGS. 2C-2D, 10, 11). Pseudocode and the complete backpropagation protocol are described in further detail below. Note that digital and analog gradient update steps can both be implemented in parallel across all PNN layers once the measurements from forward and backward steps are determined.

We experimentally estimated the accuracy of the analog gradient measurement for a matrix optimization problem by digital processing of the optical power measurements (FIG. 2D). We programmed a sequence of inputs into the generator unit of our chip and recorded the square wave response oscillating between p_{η},+ and p_{η},− and separately subtracted the two measurements to find the gradient with respect to q.

We implemented in situ backpropagation in a single photonic mesh layer optimizing the cost function defined for output port i via

$${ℒ}_{r} = 1 - {\vert {\hat{u}}_{r}^{T} {u}_{r}^{*} \vert}^{2}$$

or a “batch” cost function

$$ℒ = {\sum }_{r = 1}^{4} {ℒ}_{r} / 4$$

averaged over 4 inputs (“batch size” M=4). Here, uᵣ is row r of U, a target matrix that we chose to be the four-point discrete Fourier transform (DFT), and uᵣ is row r of Û, the implemented matrix on the device. For our gradient measurement step, we sent in the derivative

$${y}_{adj} = \partial {ℒ}_{r} / \partial y = - 2 {( {\hat{u}}_{r}^{T} {u}_{r}^{*} )}^{*} {e}_{r}$$

to measure an adjoint field x_{adj}, where eᵣ is the r^{th} standard basis vector (1 at position m, 0 everywhere else).

We evaluated gradient direction error as 1−g·ĝ comparing normalized measured (ĝ) and predicted gradients

g=∂ [symbol] /θ_{η}·∥∂ [symbol] /∂_{η}∥⁻¹.

Both digital and analog gradients were less accurate near convergence, with the errors empirically decreasing quadratically with cost [symbol] (FIG. 2F). The analog batch gradient (trained by summing all four gradients together to give ∂ [symbol] /∂_{η}) validated the photonic portion of the batch scheme (FIGS. 10B, 11). All gradient errors, regardless of implementation, scaled similarly with convergence distance; uncalibrated thermal crosstalk likely resulted in gradient measurement errors comparable to systematic power errors at the taps. Digital subtraction encountered different losses and coupling efficiencies in bidirectional gratings, whereas analog gradient measurements involved subtraction of only forward-going fields at forward gratings, likely resulting in superior performance (FIG. 2F). Finally, error in the full analog subtraction scheme was independent of batch size for the gradient calculation, and no significant deviation due to timing jitter or signal distortion was observed (FIGS. 11A-11D).

### Photonic Neural Network Training

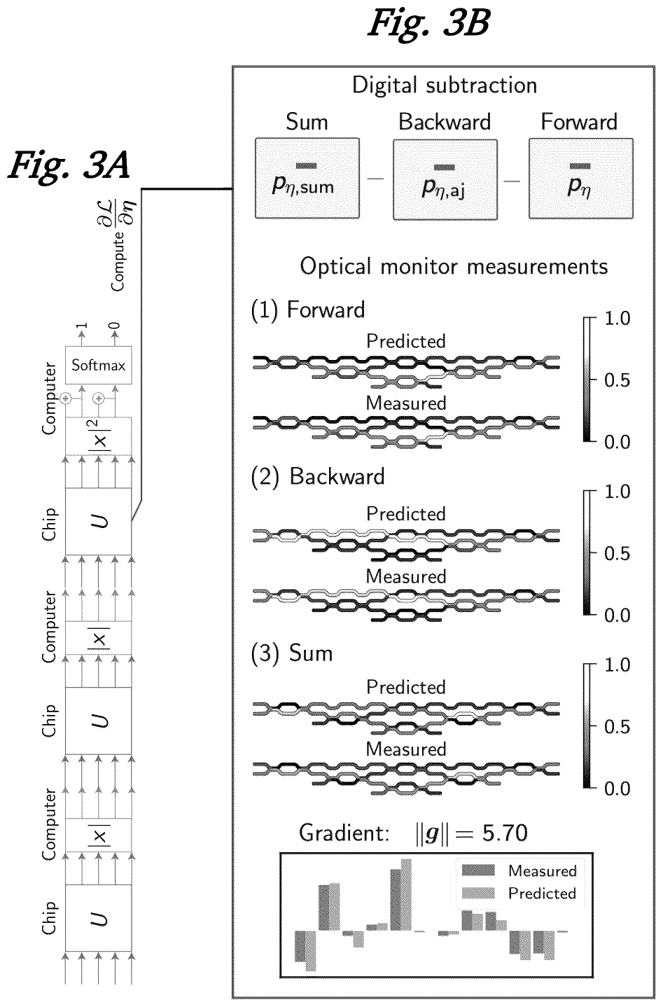

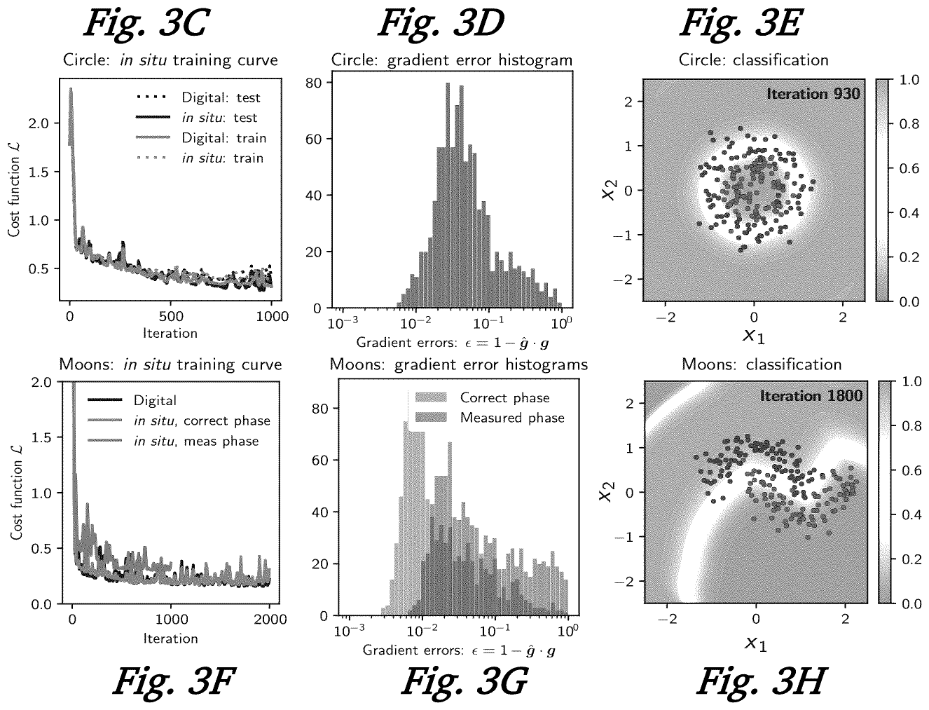

FIGS. 3A-3H illustrate an in situ backpropagation example. In situ backpropagation training was performed for two classification tasks solvable by a three layer hybrid PNN shown in FIG. 3A having absolute value nonlinearities and a softmax (effectively sigmoid) decision layer. FIG. 3B shows three-step digital subtraction gradient update given monitored waveguide powers and the measured gradient output. As illustrated in FIG. 3C, for the circle dataset, the digital and in situ backpropagation training curves show excellent agreement, resulting in model accuracy (FIG. 3E) of 96% test and 93% model (depicted here for iteration 930, showing the true labels and the learned classification model outcomes) and histogram (FIG. 3D) of low gradient error. For the moons dataset, our phase measurements were sufficiently inaccurate due to hardware error to impact training leading to a lower model train accuracy of 87% (FIG. 3F). Using ground truth phase, the device achieved sufficiently high model test accuracy 98%, train 95% (FIG. 3H). The histogram of gradient errors improved considerably by roughly an order of magnitude using the correct phase measurement (FIG. 3G).

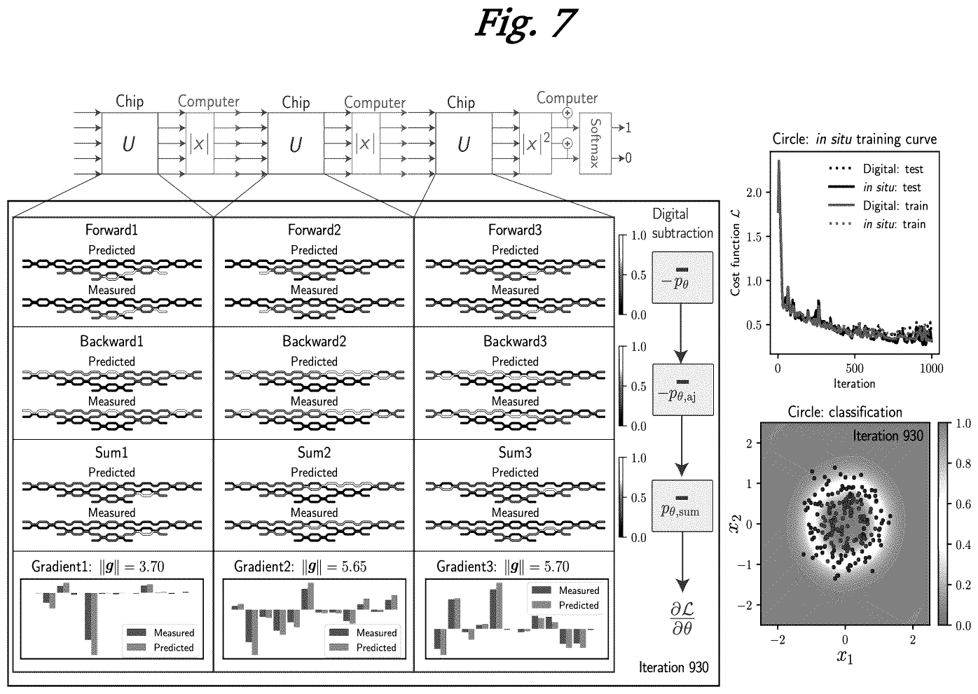

To test overall on-chip training, we assessed accuracy of in situ backpropagation to train multi-layer PNNs using a digital subtraction protocol (FIGS. 3A, 7) automated using Python software. We trained our chip to implement L=3 layers with N=4 ports to assign labelled noisy synthetic data, generated using Scikit-Learn, in 2D space to a 0 or 1 label based on the point's spatial location (FIGS. 1A, 3E, 3H, 8I-8J). We performed a 80%:20% train-test split (200 train points, 50 test points) to avoid overfitting.

To implement classification, our PNN assigned a probability to each point being assigned a 0 or 1 based on the following model:

$$\hat{z} ( x ) = softmax 2 ( \vert {U}^{( 3 )} \vert {U}^{( 2 )} \vert {U}^{( 1 )} x \vert \vert \vert ) , \qquad ( 4 )$$

where softmax2 is the standard softmax (normalized sigmoid) function applied to two quantities: the total power in outputs 1, 2 and total power in ports 3, 4. The input data x was engineered such that any 2D point had the same total input power as a four port vector.

Each point was classified red or blue (0 or 1 respectively) based on whether output of eq. 4 obeyed the condition z₀>z₁ for each input (FIGS. 3A-3H), which we optimized using a cross entropy cost function.

Our chip performed data input, output and matrix operations for all PNN layers. At each layer output, we digitally performed a square-root operation on output power to implement absolute value nonlinearities (off-chip via JAX and Haiku) and recorded output phases for the backward pass of in situ backpropagation. Ideally, PNNs are controlled by separate photonic meshes of MZIs for each linear layer to achieve low power consumption. However, to save on footprint we reprogrammed the same chip to perform successive linear layers since basic operating principles remain the same. We used the Adam gradient update with a learning rate of 0.01 and performed digital simulations at each step to fully compare measured and predicted performance.

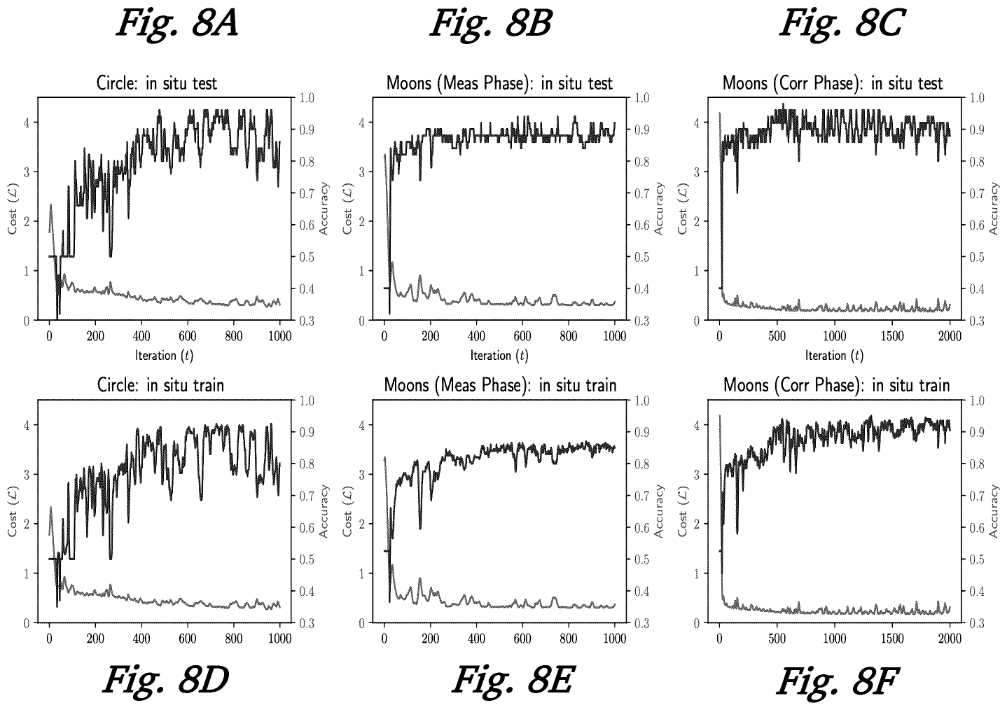

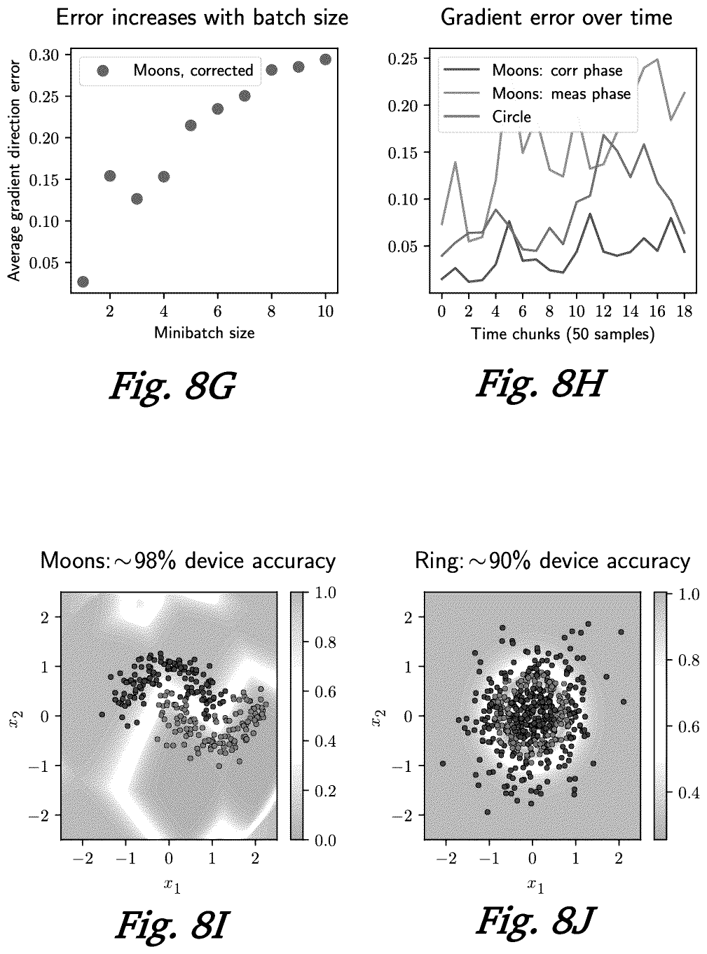

Before on-chip training experiments, we calibrated all phase shifters on the chip (see FIGS. 6A-6E) and performed forward inference with digitally pre-trained neural network weights to verify accurate calibration. We achieved 90% and 98% device test set accuracy for ring and moons datasets respectively (FIG. 8I-8J). Since our photonic and digital implementation agreed closely in inference accuracy, we performed network training on-chip while conducting evaluations off-chip for convenience.

During training of the circle dataset, predicted and measured powers for grating tap-to-camera monitor measurements showed excellent agreement across all waveguide segments required for accurate gradient computation (FIGS. 3B, 7). The training curves in FIG. 3C indicate that stochastic gradient descent was a highly noisy training process for both predicted and measured curves due to the noisy synthetic dataset about the boundary and our choice of single-example training. These large swings appeared roughly correlated between the simulated and measured training curves (FIG. 3E), and we successfully achieved 96% train and 93% test model accuracy (FIGS. 3D, 8A-8C). We then trained the moons dataset, applying same procedure to achieve 87% train and 94% test model accuracy (FIG. 3F, green vs red). When using the predicted phase and measured amplitudes, we reduced gradient error by roughly an order of magnitude on average resulting in 95% train and 98% test model accuracy (FIG. 8D-8F) which agreed with digital training (FIG. 3F-3H). This improvement underscores the importance of accurate phase measurement for improved training efficiency. Further monitoring errors could be reduced by increasing signal-to-noise ratio using integrated avalanche photodiodes, CLIPP monitoring or phase shifter-based power monitoring.

### Simulations and Scalability

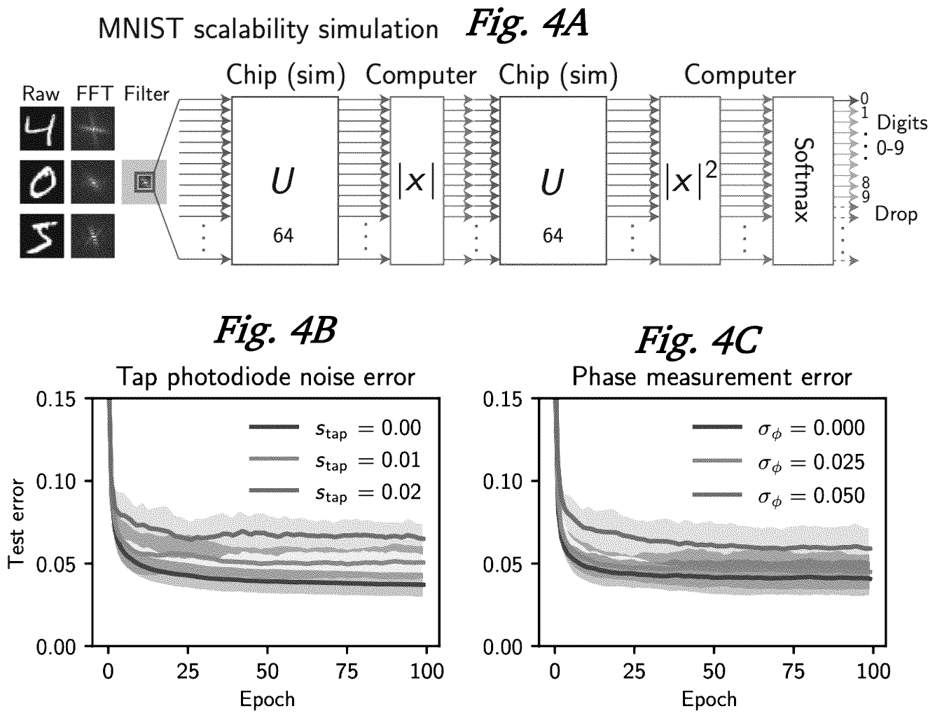

FIGS. 4A-4C illustrate an in situ backpropagation simulation. FIG. 4A is a schematic diagram of a two-layer PNN simulated on MNIST data using a previously explored PNN benchmark. FIGS. 4B, 4C are graphs showing marginal training curve statistics (shaded regions indicate standard deviation error range about the mean), computed over a grid search of 72 tap noise, loss, and I/O amplitude and phase errors. The dominant contributers were: (FIG. 4B) tap noise factor sₜₐₚ (2.7% increase for sₜₐₚ=0.02 from 3.7±0.7% average error) and (FIG. 4C) phase error σ_{ϕ}(1.9% increase for σ_{ϕ}=0.05 from 4±1% average error).

Given that our experimental results for N=4 PNNs showed evidence of hardware error impacting training, we assessed the scalability for N=64 PNNs on the MNIST handwritten digit dataset in the presence of error to better understand the relative contributions at scale. We implemented a PNN simulation framework in Simphox using JAX and Haiku to simulate an in situ backpropagation training given a grid search of systematic and noise errors. After 100 epochs using M=600 batch size, we achieved a maximum test accuracy of roughly 97.2% in the ideal case and a performance degradation to roughly 95% on average (FIG. 4B-4C). Phase and amplitude errors arising from photodetector noise and phase shift quantization and calibration errors affected convergence in error the most. This suggests in-situ backpropagation is relatively robust at scale to noise and hardware errors, which are difficult to totally eliminate in current analog computing systems.

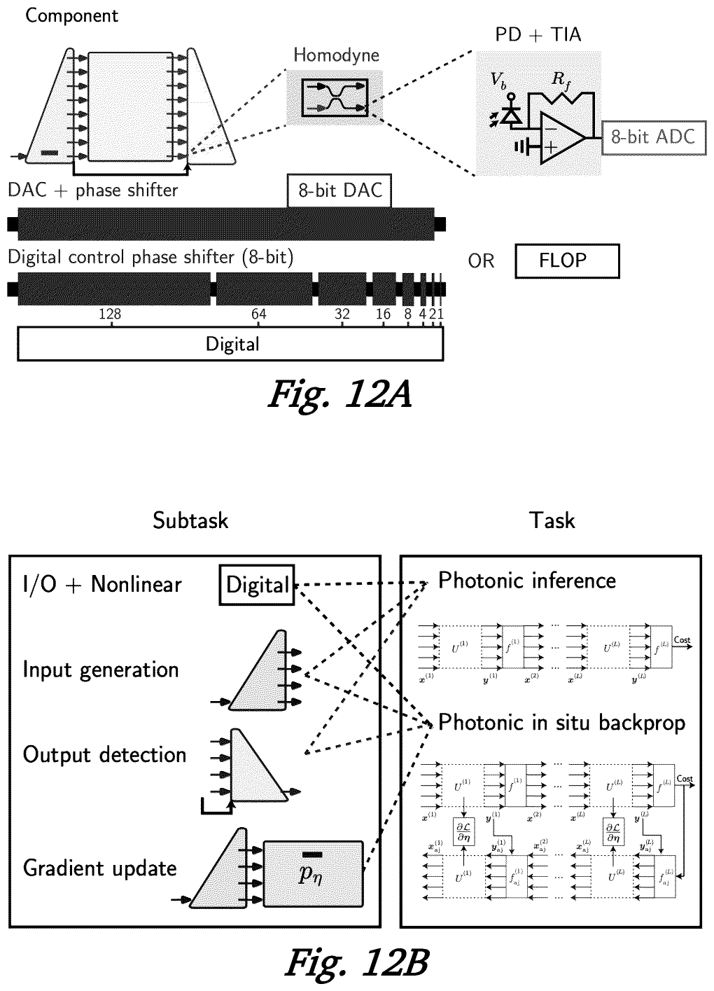

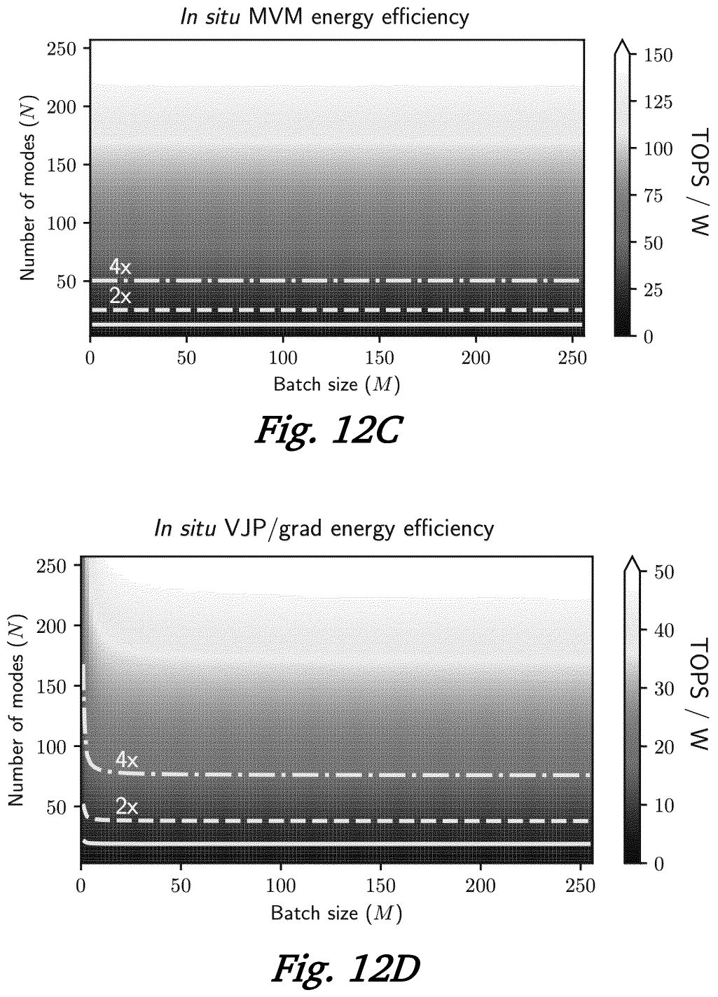

We also considered the energy and latency tradeoff with accuracy for the optimized analog gradient update scheme assuming current state-of-the-art electronics co-integrated with active photonic components. Collectively, our simulation results (FIGS. 4A-4C) and energy calculation contours (FIGS. 12A-12D, supported by Tables 1-6) indicated minimal performance degradation for MNIST training simultaneously with 3x improvement in backpropagation energy efficiency assuming 100 fJ floating point operations for equivalent digital models and tap noise factor of sₜₐₚ<0.01 in the regime where optical power begins to dominate the energy consumption. Errors may be further reduced by improving avalanche photodiode sensitivity, reducing optical component loss, or increasing overall input optical power, a key factor in the energy-error tradeoff (Tables 1-6). Tradeoff of input power and photodiode noise generally enforces a hard limit on scalability of photonic matrix multiplication since all photonic components have loss.

### Discussion and Outlook

We demonstrated practically useful photonic machine learning hardware by physically measuring gradients calculated via interferometric measurements of in situ backpropagation (FIGS. 1A-1E). We concluded that gradient accuracy played an important role in reaching optimal results during training and decreases quadratically near convergence (FIG. 2A-2F).

As a core application, we trained multilayer PNNs using our gradient measurements, and saw good agreement with digital training simulations despite optical I/O calibration errors and camera noise at the global monitoring taps (FIGS. 3A-3H). Correcting for phase error yielded training curves highly correlated to digital predictions, so optical I/O calibration accuracy is vital. Even though individual updates were ideally faster to compute, higher error resulted in effectively longer training times that mitigated this benefit. To better understand this tradeoff, we explored an optimized regime of our system, which considered co-integration of CMOS electronics with photonics (FIGS. 12A-12D, Tables 1-6), and found that in the regime of photonic advantage (e.g., N=64 at sufficiently large batch sizes), we could successfully train MNIST close to digital equivalents (FIGS. 4A-4C).

Our demonstration (FIGS. 3A-3H) and energy calculations (FIGS. 12A-12D) show that in situ backpropagation, a technique widely used in machine learning for its efficiency, also efficiently trains hybrid PNNs. Our hybrid approach optically accelerated the most computationally intensive [symbol] (N²) operations, while nonlinearities and their derivatives, which are [symbol] (N) computations, were implemented digitally. This is reasonable because [symbol] (ON) time is required to modulate and measure optical inputs and outputs for the overall network, regardless of hybrid or all-analog operation. Since optics is ideal for low-latency and low-energy signal communication, our in situ backpropagation scheme improves energy efficiency in data center machine learning and neural network accelerators (e.g., GPUs) with optical interconnects, where data is already optically encoded. Such schemes may be compatible with mixed-signal schemes for accelerators that already aim to reduce the communication bottleneck in the race to address the energy doubling AI problem.

Population-based methods, direct feedback alignment, and perturbative approaches have some advantages but are ultimately less efficient for training neural networks compared to backpropagation, especially for hybrid PNNs. Unlike “receiverless” fully analog PNNs, hybrid PNNs use optoelectronic (i.e., digital-analog and analog-digital) conversions for each layer, which can slow down perturbative training. In contrast to perturbative approaches, in situ backpropagation calculates gradients in a modular framework compatible with larger scale AI applications.

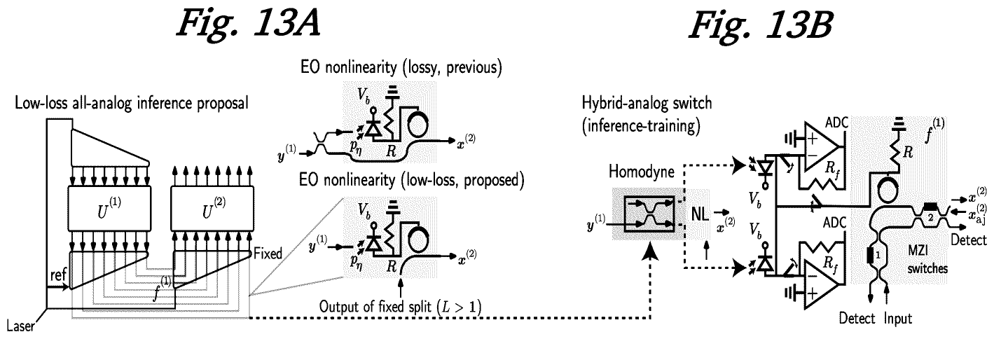

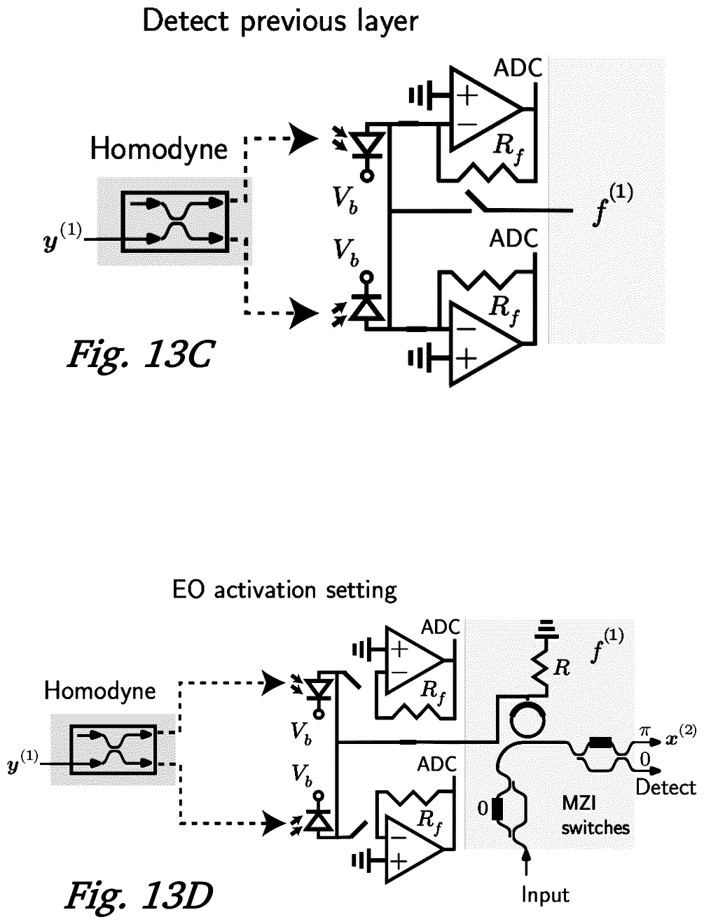

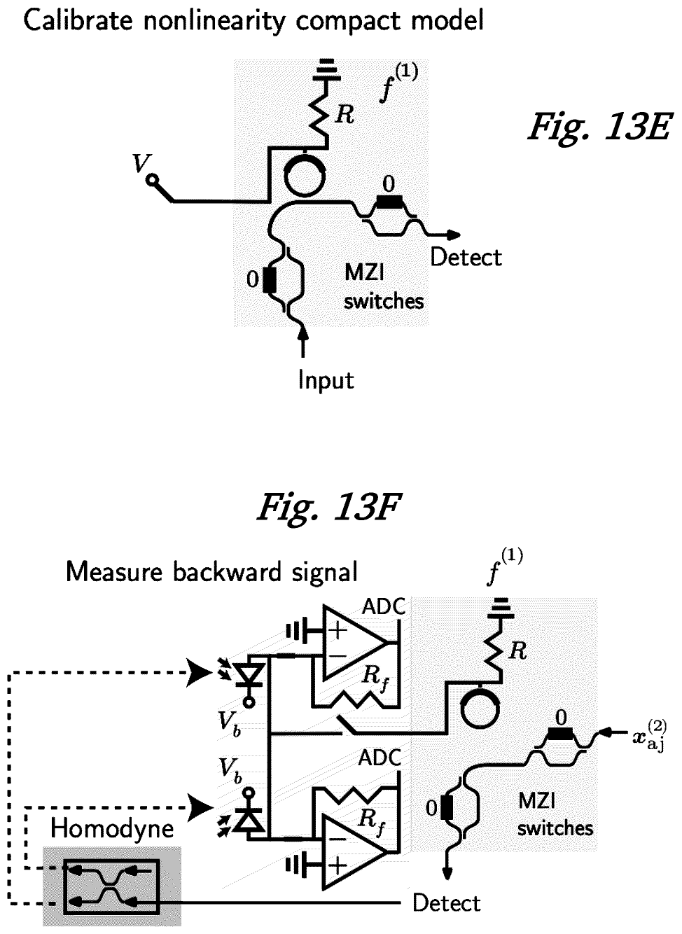

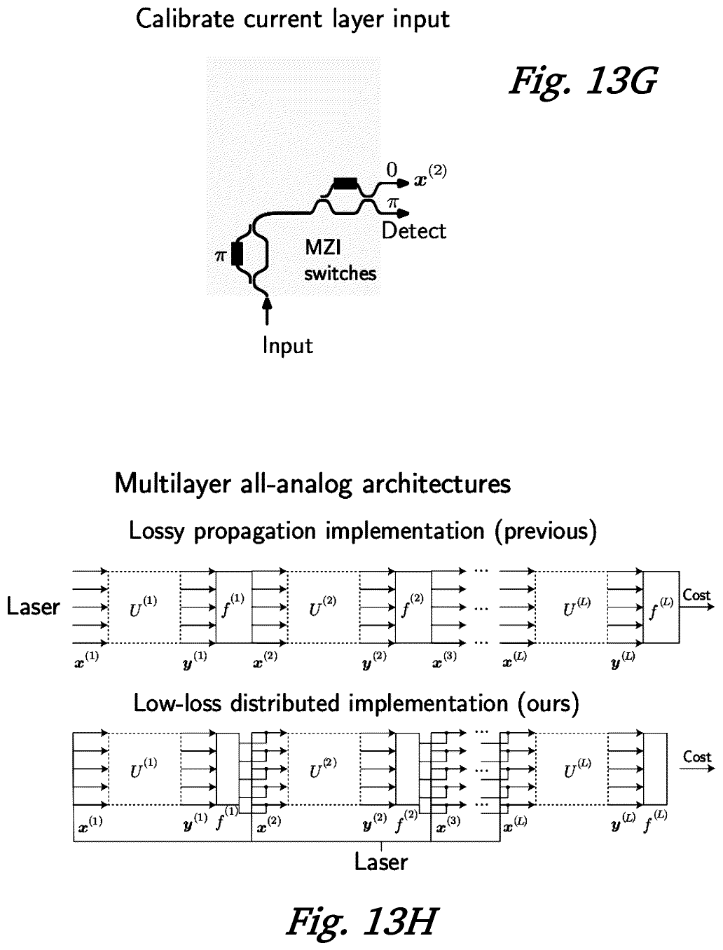

Although this work primarily dealt with hybrid PNNs, our backpropagation scheme may also be used with all-analog or receiverless implementations implementing EO nonlinearities on-chip. Previous all-analog PNN implementations have suffered from exponential loss scaling because the same optical modes propagated through all L layers. We reduce this scaling from exponential to linear by instead splitting input light equally across the layers and modulating each layer input by EO activations that depend on other layer output powers, which acts to “connect” the layers without an explicit optical connection (FIGS. 13A, 13H). After incorporating electronic and optical switches, this “distributed nonlinearity” architecture can operate as a hybrid PNN platform for training or an all-analog platform for inference with full visibility of EO nonlinearity response to aid backpropagation training (FIG. 13B-13G).

Ultimately, these all-analog schemes suffer from limited versatility to manipulate or transform data. Depending on the problem or architecture, “hybridizing” the all-optical PNN with digital platforms can add some flexibility when convenient at the expense of optoelectronic conversion energy. For instance, flexibility of large scale hybrid PNN models has been demonstrated via high ResNet-50 image classification accuracy using commercially viable photonic meshes. Our experimental demonstration provides a way to train such models on backpropagation-enabled devices that few other training methods can efficiently produce. In situ backpropagation can also train “optical transformers” that leverage hybrid PNNs for natural language and video processing applications. The periodic application of digital activations currently infeasible in optics (e.g., layer normalization) enables one-to-one correspondence of hybrid PNNs and state-of-the-art large-scale NN models.

Our demonstration is an experimental analogue of “inverse design” of photonic devices. Inverse design implements reverse-mode autodifferentiation with respect to material relative permittivity by interfering adjoint and forward fields. This forms the basis of the original proof of in situ backpropagation since phases are trivially related to material relative permittivity changes. This suggests an even broader application domain for our technique to optimizing arbitrary programmable linear optical devices with no obvious calibration scheme, including robust multi-waveguide interferometers and recirculating designs. The analog gradient update experiment in FIG. 2A-2F is relevant to calibration because minimizing the cost function [symbol] maximizes device fidelity.

Our results ultimately have wide-ranging implications for bridging the fields of photonics and machine learning. Backpropagation is the most efficient and widely used neural network training algorithm for machine learning, and our demonstration of this popular technique as a physical implementation presents promising capabilities of hybrid PNNs to reduce carbon footprint and counter the exponentially increasing costs of AI computation.

### Circuit Design and Packaging

Our photonic integrated circuit was a 6×6 triangular photonic mesh with a total of 15 MZIs fabricated at the AdvancedMicroFoundry (AMF) in Singapore designed using our photonic library DPhox, which is a custom automated photonic design library in Python.

Each of the MZIs in the mesh was controlled using programmable phase shifters in the form of 80 μm×2 μm titanium nitride heaters with 10.5 ohm/sq sheet resistance surrounded by deep trenches that were 80 μm×10 μm and a total of 7 μm away from the waveguide, which used resistive heating to control the interference of light propagating in the chip. The MZIs have two 50/50 directional couplers, with S-bends having 30 μm radius arc turns and 40 μm long interaction lengths with a 300 nm gap. Next to each of the phase shifters was a bidirectional grating tap monitor, which is a directional coupler tap that couples 3% of the light propagating either forward or backward through the waveguide attached to the tap and feeds that light to a grating to be imaged on a camera focused on the grating. Traces for one of the terminals of each of the phase shifters were routed to separate individual pads on the edge of the chip, and the ground connections across all phase shifters in a column of MZIs were shared and connected to a single ground pad. The trace widths needed to be thick enough to handle high thermal currents, so 15 μm wide traces and 15N_{wire} μm wide traces were used when multiple connections were connected to a shared ground contact to avoid electrical crosstalk.

The photonic chip was attached using silver paint to a 1.5 mm thick copper shim and a custom Advanced Circuits PCB designed in KiCAD with ENIG coated metal traces to interface the phase shifters with an NI PCIe-6739 controller for setting programmable phase shifts throughout the device. The PCB was wirebonded using two-tier wirebonding to the chip by Silitronics Solutions, made possible by fanout to NI SCB-68 connectors that interfaced directly to the PCIe-6739 system. The input optical source was an Agilent 81606A tunable laser with a tunable range of 1460 nm to 1580 nm. The laser light was coupled into a single-mode fiber and optically interfaced to the chip using W2 Optronics 127 micron pitch fiber array interposers at the left and right sides of the mesh, with a mirror facet designed to couple optical signals at 10 degrees from the normal as only a single grating coupler was coupled for each fiber array coupler. Optical stray reflections from light not coupled into the chip generally interfered with grating tap signals forming extra streaks in the camera; these stray reflections were blocked using pieces of paper carefully placed above the fiber arrays that acted as lightweight removable stray light blockers.

For thermal stability, this chip-PCB assembly was thermally connected to a thermoelectric cooler (TEC). This thermal connection was made possible by metal vias connecting rectangular ENIG-coated copper patches on the top of the PCB to the bottom of the PCB, with thermal paste between an aluminum heat sink mount and the bottom rectangular metal patch. For feedback control, a thermistor placed near the chip and the TEC under the chip were attached to a TEC controller unit, allowing stable chip temperature (kept at 30° C.) for training.

FIGS. 5A-5E illustrate an experimental setup. FIG. 5A is a grating monitor closeup showing the bidirectional grating tap used to perform the backpropagation protocol. FIG. 5B is an image showing metal trace, via, and TiN (titanium nitride) phase shifter colocated with the grating monitor and used to control the interference by changing optical phase in the mesh programmatically. Deep trenches are used for thermal isolation. Here, the phase shifter image at its focal plane is overlaid on the top metal trace and via used to connect each phase shifter to the pads. FIG. 5C shows fiber array inputs to the photonic mesh spaced 127 μm apart and used for interfacing fiber arrays. FIG. 5D is a large scale view of a section of the chip where phase shifters are routed to pads and MZI network connections can be seen. FIG. 5E is an image of the experimental setup with the PCB, showing a microscope mounted on an ASI movable stage to image spots (Thorlabs parts), Thorlabs polarization controller, W2 Optronics fiber arrays, ThorLabs fiber switch, Xenics Bobcat IR camera for bidirectional operation. (Not shown are DAC control unit, thermoelectric cooler control feedback.)

### Optical Rig Design

Our optical rig (FIG. 5E) included an Ethernet cable-connected Xenics Bobcat 640 IR camera and microscope assembly mounted on an XY stage and six-axis stages for free space fiber alignment. The IR camera and microscope imaged individual grating taps throughout a photonic integrated circuit (PIC) and was responsible for all measurement on the chip (both optical I/O and optical gradient monitoring).

The microscope used an ∞-corrected Mitutuyo IR 10× objective and a 40 cm tube lens leading to a dichroic connected to visible and IR optical paths for simultaneous visible and infrared imaging. The optical rig was also outfitted with additional paths for LEDs to illuminate the actual chip features. This allowed us to find the optimal focus for the grating spots, an image shown in FIG. 2A. In order to measure intensities directly using the IR camera, the Bobcat camera “Raw” mode was turned on and autogain features were turned off. For the main training demonstration (FIGS. 3A-3H), integration time was set to 1 ms, and the input laser power was set to 3 mW and for the analog update validation, integration time was set to 3 ms while the input laser power was set to 400 μW; note that higher integration times were required for lower input laser powers. An initial reference image was taken to get a baseline and then to measure the spots intensities or powers, the camera pixel values that “filled” the given appropriate grating tap in the device were summed. The triangular mesh circuit was constructed such that the grating taps lay along columns of devices, which meant the optical rig imaged a 6×19 array of spots. The infrared path had roughly a 700×600 μm field of view, allowing simultaneous measurements of 6×3 grating spots on the chip (MZIs were 625 μm long in total given roughly 165 μm long directional couplers), which necessitated an XY translation stage to image multiple spots simultaneously on the chip.

The speed of backpropagation was limited by the mechanics of the XY stage used to image spots throughout the chip, so our demonstration training experiments took up to 31 hours of real time to run, limited primarily by the wait time for the stage to settle on various groups of spots on the chip. Assuming T iterations, the stage needed to move a total of 15T times (5 for each of the three in situ backpropagation steps to be able to image all of the spots). For 1000 iterations, the stage needed to move a total of 15000 times which necessitated the need for automation for the stage of our proof-of-concept demonstration. In a final commercial implementation, the grating taps would be replaced by integrated photodetectors; there would in principle be no separate optical rig system in a fully packaged hybrid digital-analog photonic circuit. As far as energy consumption, most of the energy was in the operation of the NI DAQ unit which used 100s of watts for special applications, and then the camera (4 W) and the phase shifters (50 mW each). More latency and energy consumption analysis of the optimized form of our proof-of-principle proposal is provided in future sections and replaces these components with zero-energy static phase shifts, integrated photodetectors, and digital control phase shifters.

### Calibration

For our calibration protocol of analyzers and generators (see sec. 2.4 for complete defi-nition and operating principles), phase shifts were swept while recording an MZI split ratio measured using camera spots immediately after an assigned MZI depending on the calibrated phase shifter. An MZI split ratio can be represented in terms of a transmissivity t=sin² θ, where θ is twice the phase shift in the internal arm, which is used for calibration:

$$t = \frac{{p}_{t}}{p} \approx \frac{{p}_{t}}{{p}_{r} + {p}_{t}} \qquad ( 5 )$$

where t is the transmissivity, p is the total power at the input, pt is the cross state grating power and pᵣ is the bar state grating power determined by summing up pixel values from the camera.

The model is:

$$θ = {p}_{0} {v}^{3} + {p}_{1} {v}^{2} + {p}_{2} v + {p}_{3} t = a sin θ + b . \qquad ( 6 )$$

Empirically, it sufficed to fit

v²=q₀θ³+g₁θ²+q₂θ+q₃

to convert voltage to phase.

For algorithmically calibrating the phase shifts, we used interferometers within the mesh to first calibrate all θ internal phase shifts from left to right by routing light via “lightwires” to all MZIs in the device, as shown in FIG. 6A.

We then used “meta-MZI” structures within the mesh to calibrate all of the ϕ external phase shifters as shown in FIG. 6B. For this calibration, after we calibrated each of the ϕ phase shifters, we set ϕ=0 so that the other ϕ phase shifter in the meta-MZI has a consistent calibrated phase. Repeating this procedure for all ϕ phase shifts was sufficient to ensure that phase calibrations were all mutually consistent.

FIGS. 6A-6E illustrate calibration of thermal phase shifters. FIG. 6A shows calibration of θ internal phase shifts using lightwires leading to MZIs. FIG. 6B shows calibration of #phase shifts using lightwires leading to meta-MZI structures created out of four neighboring MZIs. FIG. 6C is a graph of phase shifter calibration showing excellent fit to eq. 6. FIG. 6D shows raw camera spot measurements, illustrating that different grating taps have different coupling efficiencies (a source of error in gradient measurements). FIG. 6E is a graph showing a linear regime of the calibration curve, illustrating the range of voltages that need to be applied to our phase shifters to ensure that a full [0, 2π) range can be achieved.

### Forward Inference Operation

Forward inference proceeded as follows for layer [symbol] (see FIG. 1A) where each step is O(N):
1. Compute the sets of phase shifter settings

$${θ}_{X}^{( ℓ )} , {ϕ}_{X}^{( ℓ )}$$

for the generator to give the desired vector [symbol] of complex input amplitudes for the Matrix unit in layer [symbol] .
2. Set these as the actual phase shifts in the generator phase shifters using calibration curves for V_{θ}(θ), V_{ϕ}(ϕ) and shine light into the generator circuit to create the corresponding actual vector of optical input amplitudes for the Matrix unit.
3. After the propagation of light through the Matrix unit, the system has optically evaluated the vector of complex optical output amplitudes [symbol] Now self-configure the output analyzer circuit to give all the output power in the “top” output waveguide, and note the corresponding sets of voltages v_{ϕ} and voltages v_{θ} now applied to each phase shifter in the generator circuit.
4. Deduce the phase shifts

$${θ}_{Y}^{( ℓ )} , {ϕ}_{Y}^{( ℓ )}$$

in the analyzer circuit using calibration curves for θ(V_{θ}), ϕ(V_{ϕ}), and hence compute the corresponding measured output amplitudes [symbol] .
5. Compute [symbol] on the computer.

The first four steps were also used in cases where light was sent backwards (see FIG. 1G, 1H), switching the role of the input and output vector units from generator to analyzer and vice versa. Full pseudocode for the forward operation of the PNN is provided in Algs. 1-5, and code for the actual implementation is provided in our photonic simulation and control framework Phox and simulation framework Simphox.

### Backpropagation Protocol

For each training example (x, z), gradient updates to phase shifts η were calculated using a “backward pass” corresponding to the inference “forward pass” for that data. More formally, a “vector-Jacobian product” or VJP can be defined for each function [symbol] to algorithmically compute the gradient of the cost function [symbol] . As shown in FIG. 1C, each transformation from the forward step is mapped to a VJP in the corresponding backward step (defined in decreasing order from layer L to 1) which depends on intermediate function evaluations in both forward and backward passes. The in situ backpropagation step implements the costly intermediate VJP evaluations (i.e., matrix multiplications) directly in the analog optical domain. We define the VJP for nonlinearity

$${f}^{( ℓ )} ( {y}^{( ℓ )} ) as {f}_{vjp}^{( ℓ )} ( {y}^{( ℓ )} , {x}_{adj}^{( ℓ + 1 )} ) :$$

$${y}_{adj}^{( ℓ )} = {f}_{vjp}^{( ℓ )} ( {y}^{( ℓ )} , {x}_{adj}^{( ℓ + 1 )} ) {x}_{adj}^{( ℓ )} = {( {U}^{( ℓ )} )}^{T} {y}_{adj}^{( ℓ )} \qquad ( 7 )$$

Finally, we synthesize Eqs. 1 and 2 and eq. 7 to get the backpropagation update based on applying the chain rule evaluating the cost function at a random training example xₜ, zₜ at iteration t:

$$\frac{\partial ℒ}{\partial {η}^{( ℓ )}} = \frac{\partial {y}^{( ℓ )}}{\partial {η}^{( ℓ )}} \overbrace{\frac{\partial {x}^{( ℓ + 1 )}}{\partial {y}^{( ℓ )}} … \underbrace{\frac{\partial \hat{z}}{\partial {y}^{( L )}} \frac{\partial ℒ}{\partial \hat{z}}}_{{y}_{adj}^{( L )}}}^{{x}_{adj}^{( ℓ )}} {\vert}_{{x}_{t} , {z}_{t}} \qquad ( 8 )$$

$$\begin{matrix}= \overbrace{\frac{\partial {y}^{( ℓ )}}{\partial {η}^{( ℓ )}}}^{{D}_{ℓ} \times N Jacobian} \cdot \overbrace{{x}_{adj}^{( ℓ )}}^{N \times 1 vector} \\ = \overbrace{{( {x}^{( ℓ )} )}^{T} \frac{\partial {U}^{( ℓ )}}{\partial {η}^{( ℓ )}} {x}_{adj}^{( ℓ )}}^{“ optical VJP ”} = \overbrace{- ℐ ( {x}_{{η}^{( ℓ )}} {x}_{{η}^{( ℓ )} , adj} )}^{{D}_{ℓ} \times 1 in situ gradient} \\ {η}_{t} := {η}_{t - 1} + α \frac{\partial ℒ}{\partial η} {\vert}_{{x}_{t} , {z}_{t}}\end{matrix}$$

where x_{η} represents a vector of intermediate fields at the input of phase shifters in layer [symbol] at iteration t, [symbol] is the number of phase shifts parametrizing the device at layer [symbol] , [symbol] I refers to imaginary part, and a is the learning rate. The main idea is that if enough training examples are supplied (i.e., after T updates), the device will automatically discover or “learn” a function that performs the task we desire.

Based on eq. 7, the steps of our optical VJP step, as depicted in FIG. 1C), is as follows in order from layer [symbol] =L to 1 of the photonic neural network:
1. Compute the “adjoint” vector

$${y}_{adj}^{( ℓ )} = {f}_{vjp}^{( ℓ )} ( {y}^{( ℓ )} , {x}_{adj}^{( ℓ + ℓ )} ) .$$

For the last layer, set

$${y}_{adj}^{( ℓ )}$$

to be the error signal

$${y}_{adj}^{( ℓ )} = {( \frac{\partial ℒ}{\partial {x}^{( L + 1 )}} )}^{*} .$$

2. Perform the backward “adjoint” pass

$${x}_{adj}^{( ℓ )} = {U}^{T} {y}_{adj}^{( ℓ )}$$

by sending light backwards through layer [symbol] of the mesh and measuring the resulting vector of amplitudes

$${x}_{adj}^{( ℓ )}$$

emerging backwards from the mesh.
3. Send the vector of optical amplitudes

$${x}^{( ℓ )} - i {( {x}_{adj}^{( ℓ )} )}^{*}$$

forward into layer [symbol] of the mesh.
4. Measure gradient ∂ [symbol] /∂_{η} for any phase shifter η:
   (a) If using digital subtraction measurement, measure the sum power p_{η,+} and subtract p_{η} and p_{η,adj} (monitored power from forward and backward steps) to get the gradient.
   (b) If using analog gradient measurement, toggle the adjoint global phase ζ (giving

$${x}^{( ℓ )} - i ( {x}_{adj}^{( ℓ )} ) * {e}^{i ζ} )$$

between 0 and π a set number of times K (e.g., K=10). Use a high-pass filter and comparator to measure the AC component of the measured power through phase shifter η, p_{η,+}−p_{η,-} with sum and diff defined at ζ=0, π respectively. The resulting gradient is (p_{η,+}−p_{η,-})/4.
5. Update η using measured gradients ∂L/∂_{η}.

Note that Step 1 can be simplified to

$${y}_{adj}^{( ℓ )} = {( {f}^{( ℓ )} )}^{′} ( {y}^{( ℓ )} ) ⊙ {x}_{adj}^{( ℓ + 1 )}$$

in the case that [symbol] is holomorphic, or complex-differentiable. For the neural network parametrized by eq. 4, we specifically care about the nonlinearity [symbol] (y)=|y|, which has the associated VJP:

$${f}_{vjp}^{( ℓ )} ( y , {x}_{adj} ) = \frac{y}{\vert y \vert} \cdot ℛ ( {x}_{adj} ) . \qquad ( 9 )$$

The other VJP used to calculate ∂ [symbol] /∂y^{(L)} from the final softmax cross entropy and power measurement at the end of the network is handled by automatic differentiation.

Steps 3 and 4 can in principle be parallelized over all layers (i.e., parameters of the network) for both the digital and analog update schemes. Pseudocode for the overall protocol (using digital subtraction), along with an energy-efficient proposal for analog gradient computation, is discussed later in see 2.5. The final step can be achieved using “stochastic gradient descent” (which independently updates the cost function based on randomly chosen training examples) or adaptive learning where the update vector depends both on past updates and the new gradient. A successful and commonly used implementation of this, used in this work, is called the Adam update.

### Backpropagation Mnist Simulation in Simphox

We simulated analog in situ backpropagation classifying 28×28 MNIST handwritten digit images to the appropriate digit (0 to 9) using a previously investigated two-layer PNN with rectangular meshes and absolute-value and softmax nonlinearities (FIG. 4A). At the end, we applied a CE cost function paying attention to the first 10 outputs of \hat{z},

$$ℒ ( x ) = CE ( \hat{z} ( x ) , z ) = {\sum }_{i = 1}^{10} {z}_{i} log {\hat{z}}_{i} .$$

To train this PNN in a digital simulation of our proposal, we implemented the primitive function in_situ_matrix_function in simphox circuit module following the pseudocode of alg. 4. We explored a grid search of different errors including input and output phase (σₐₘₚ=0,0.025,0.05) and amplitude fractional error (σₚₕₐₛₑ=0,0.025,0.05), tap noise factor (sₜₐₚ=0, 0.005, 0.01, 0.02), and loss variation localized to phase shifts (σ_{dB}=0, 0.05) assumed to be the same in either propagation direction. We also studied both the SGD and Adam updates, finding a negligible difference between the two at the ideal learning rates.

Note that input and output amplitude and phase errors were modelled separately to estimate quantization error, where we estimated an 8-bit ADC at the output of each mesh resulted in a phase error of 0.025 for N=64. The noise factor sₜₐₚ (defined later below) was estimated based on required power consumption specifications and avalanche photodiode surveys and can be thought of as a measurement noise-to-signal proportionality constant. We used JAX and Haiku to optimize a general feedforward photonic neural network and logged the training curves and gradient errors in Weights and Biases, though all data is available on our Zenodo for direct analysis and data permanence.

### Analog Gradient Demonstration

As discussed earlier, the photonic portion of our proposal for analog gradients was validated using our setup by evaluating the square wave toggle digitally (depicted in FIG. 2C) and recording the result at each phase shifter on the camera. We calculated the analog and digital gradients at various Û sampled by randomly adding phase shift errors to the ideal four-point DFT U with standard deviation σ_{θ,ϕ}. Fidelity, a metric for convergence distance, was defined to be [symbol] =tr(|Û†U|²)/4=1− [symbol] , where tr is a trace, the abs value |·| is applied elementwise, and [symbol] is defined as earlier above.

To validate the use of a camera as a proxy for analog gradient measurement, we also performed a small demonstration of the full analog gradient measurement scheme on a single phase shifter for a small single-MZI learning problem. This analog demonstration was achieved using a custom electronic circuit built from operational amplifiers (TL082, Texas Instruments) for signal integration and buffering and a fiber photodetector from Thorlabs (DET08CFC).

### Hybrid Photonic Neural Network Implementation

Using our photonic mesh and digital nonlinearities implemented in JAX, we implemented and trained the model in FIGS. 3A-3H using in situ backpropagation. The neural network implemented a nonlinear boundary (for instance circle-, moon- or ring-shaped) separating noisy synthetic 2D point data of different labels in two dimensions standardized using the Python package Sklearn and specified in our code.

To solve this task, we designed a three layer PNN (FIGS. 6A-6E) where each linear layer used 4 optical ports (4×4 MVM), i.e., L=3 with N=4 inputs and outputs. The inference operation of our PNN included programming the inputs in the red generator circuit and measuring outputs on the blue analyzer circuit, reprogramming the unitary for each matrix unit layer on the same chip, and square-rooting the output power measurement off-chip to achieve absolute value nonlinearities of the form |y| (more detailed procedure described below). This unitary layer reprogramming was only intended as a proof-of-concept; the ultimate implementation would dedicate a separate optical device to each linear layer.

In the end of the final layer, we applied the function softmax2, which converted the optical signal from the third layer a two-element vector representing the probability (p₀, p₁) of 0 and 1 label respectively to be

$$softmax 2 ( y ) = \frac{( {e}^{{\vert {y}_{1} \vert}^{2} + {\vert {y}_{2} \vert}^{2}} , {e}^{{\vert {y}_{3} \vert}^{2} + {\vert {y}_{4} \vert}^{2}} )}{{e}^{{\vert {y}_{1} \vert}^{2} + {\vert {y}_{2} \vert}^{2}} + {e}^{{\vert {y}_{3} \vert}^{2} + {\vert {y}_{4} \vert}^{2}}} .$$

We then applied a cross entropy (CE) cost function [symbol] (x)=CE(z(x),z)=z₀ log \hat{z}₀+z₁ log \hat{z}₁. Input data to our device was formatted into the form (x₁, x₂, p, p), where x₁, x₂ correspond to the location in 2D space and p is some power ensuring that all inputs are normalized to the same power P, i.e.,

$${x}_{1}^{2} + {x}_{2}^{2} + 2 {p}^{2} = P .$$

After training, we found higher test than train accuracy since there were fewer noisy examples in our randomly generated test sets.

### Gradient Accuracy

As shown in FIG. 3F-3H, FIG. 7, and FIG. 8H, gradient accuracy can affect the optimization and decrease as the optimization approaches convergence. As described earlier, accurate phase measurement plays an important role in measuring accurate gradients. This is true even when the nonlinearity (as in our case with absolute value) removes the need to measure phases in the inference step. Since we evaluate the model accuracy (device-trained parameters evaluated on a theoretical computer model), we also show some evidence that the device and model classifications match quite well in FIG. 8I-8J.

One popular type of update is based on “minibatch gradient descent,” a machine learning technique that calculating gradients based on multiple training examples. This would dramatically smooth out the noisy training curves shown in FIG. 8A-8F and FIGS. 3A-3H, as the resulting averaged gradients would actually be much smaller in magnitude. However, as shown in the upper panel of FIG. 8G, we find for our 2-class training problem that the normalized error of a minibatch gradient is generally significantly higher than that of the gradient for a single training example which can have negative implications for training. In the case of our classification dataset, the variance of the gradient error remains the same when averaged over many examples, but the contribution of the gradient error is much larger over a batch. This phenomenon appears to be problem-dependent; if the average gradient for the minibatch is not closer to zero than the gradient for individual training examples, this error may not be an issue. This underscores the importance of accurate gradient measurement, which can be improved using more accurate output phase measurements; our output phase measurement alone results in an order-of-magnitude increase in gradient error.

As a word of caution, interpretation of gradient error can also be tricky; large gradient errors compared to an ideal model may be present but the ideal gradients do not reflect the static errors (loss and beamsplitter error) for which in situ backpropagation training was found to be quite robust. In other words, the fact that the gradient error is incorrect is an indicator in this case that imperfections in the photonic chip are accounted for in the on-chip gradient computation. Errors near 1 (seemingly indicating a random gradient direction) have been observed with loss errors as high as σ=0.05 with minimal impact on training.

Finally, a linear relationship between phase and voltage can help to improve gradient update accuracy without requiring nontrivial scaling complexity in the hardware. In other words, we ensure ∂ [symbol] /∂V_{θ}=∂θ/∂_{θ}·∂ [symbol] /∂θ with constant ∂θ/∂V_{θ} which simplifies the analog circuitry. The ∂θ/∂V_{θ} term is calculated using calibration curves, and this assumption is more-or-less valid in our case as we operate the phase shifters in the linear regime as shown in FIG. 6E.

FIG. 7 illustrates three-layer power monitoring profile for digital subtraction demonstration. It shows an expansion of the data shown for iteration 930 in FIGS. 3A-3H, specifically showing the intermediate power measurements at each point in the photonic neural network. As indicated by “digital subtraction,” the sum measurements are subtracted by the forward and backward measurements.

FIGS. 8A-8J are graphs of in situ backpropagation training results. FIGS. 8A-8F are graphs showing a comparison of the model cost and accuracy curves between circle, moons (measured) and moons (corrected) experiments, comparing test (FIG. 8A-8C) and train (FIG. 8D-8F) data. FIG. 8G is a graph showing the error in the gradient increases with the batch size. FIG. 8H is a graph showing the gradient error increases over the course of the optimization here shown as a time-averaged series averaged over 50-sample time (iteration) chunks. This increase has to do with the fact that near convergence, the measured gradient is smaller, leading to slightly larger errors. FIGS. 8I, 8J are plots showing device accuracy for moons and ring dataset inference tasks showing the model boundary (calculated on the computer) in the background and device-classified points. With this evidence, model and device metrics are assumed to be close enough, and model metrics are used throughout the work.

Combination with Machine Learning Software

Backpropagation is also known as automatic differentiation (AD) because any program that uses backpropagation registers a “backward” gradient function for any forward function, which is used by AD Python engines such as JAX. We demonstrate that our protocol can be easily coupled with an existing automatic differentiation framework (JAX and Haiku), which can register a backward step and adaptive update based on Adam for all unitary matrix operations as an analog in situ backpropagation gradient calculation rather than an expensive digital operation. In this way, the digital side of our hybrid PNN in principle never needs to store or have any knowledge of parameters in the photonic mesh architecture. However, in cases where adaptive gradient updates are used, such as Adam, aggregated knowledge based on past gradient updates needs to be stored; non-volatile memory may be used to energy-efficiently store these additional parameters.

Comparison with Other Training Algorithms

Backpropagation is the most widely used and efficient known algorithm for training multilayer neural network models, though it is far from the only method for calculating gradient-based updates.

Finite differences-based training has been proposed as a method of training photonic neural networks. Finite differences falls under the umbrella of perturbative learning, a well known and model-free analog machine learning technique for analog neural networks that works by perturbing each element by a small amount, or perturbing many elements simultaneously, and measuring the resulting change in the overall cost function. Perturbative learning is most useful in the context of fully optical neural networks that implement nonlinearities directly on the device, an example of which has previously been proposed for all-photonic neural networks. This has most recently been demonstrated in multilayer photonic neural networks implemented in a “receiverless” or all-optical implementation. The PNN architecture relevant for perturbative learning is therefore fundamentally different from our hybrid PNN that can benefit from in situ backpropagation.

It is worth noting that hybrid PNNs can be more versatile and useful to a larger range of traditional AI applications compared to fully analog PNNs. Many complex models (e.g., as transformers, convolutional networks, word embedding layers and recurrent neural networks) used in machine intelligence today are more easily implemented in hybrid rather than all-analog systems due to the sheer complexity and logic implemented in the model architectures.

Additionally, backpropagation is significantly more efficient than finite differences and other similar adaptive approaches. In backpropagation, the time complexity of the “forward-propagated” inference pass or direct evaluation of the model is roughly the same as that of the “backpropagated” gradient calculation pass. In contrast, a perturbative gradient calculation is significantly more costly since it cannot be computed on a layer-by-layer basis; the forward propagation must continue on to the end of the network, which does not favor our hybrid approach.

Other alternatives to backpropagation include direct-feedback alignment (DFA), derivative-free optimization and population-based learning, which include evolutionary-based (genetic algorithm or GA) and swarm-based methods. Both GA and DFA have proven successful in training optical devices at moderately challenging machine learning tasks, but less efficient at training models compared to backpropagation and have not yet been applied to challenging word processing or image machine learning benchmarks like ImageNet.

### Photonic Mesh Operation

Here, we discuss in more detail the various high level component behaviors in our chip that enable arbitrary unitary matrix multiplication.

### Bidirectional Matrix Multiplication

In photonic neural networks, programmable photonic meshes perform compute-intensive linear operations that preserve the overall power in the form of unitary transmission operator U. Meshes are configured using three subunits: an input vector generator network (generating x), a matrix network (multiplying by U), and an output vector analyzer network (measuring y). Our triangular mesh is “bidirectional” in the sense that it can represent matrix-vector operations regardless of whether the light is shined in the forward (left-to-right) or backward (right-to-left) direction as depicted in FIG. 2B, where in the latter case the output analyzer and input generator switch places.

### Tunable Splitter

A tunable splitter, the basic building block of a photonic mesh, is a 2×2 element that has a tunable split ratio region and a differential phase shifter at the input or output. For straightforward calibration, we may use Mach-Zehnder interferometer building blocks that have a differential ϕ phase shift, 50/50 splitter, differential θ phase shift, and then a final 50/50 splitter, giving us the following mathematical representation acting on modes x₁, x₂ and yielding outputs y₁, y₂:

$$[ \begin{matrix}{y}_{1} \\ {y}_{2}\end{matrix} ] = i [ \begin{matrix}{e}^{i ϕ} sin \frac{θ}{2} & cos \frac{θ}{2} \\ {e}^{i ϕ} cos \frac{θ}{2} & - sin \frac{θ}{2}\end{matrix} ] [ \begin{matrix}{x}_{1} \\ {x}_{2}\end{matrix} ] \qquad ( 10 )$$

$$y = {T}_{2} ( θ , ϕ ) x ,$$

where θ ∈[0, π] and ϕ∈[0, 2π). In practice, due to the nonlinear relationship between the phase shifts θ, ϕ and the respective voltage drives V_{θ}, V_{ϕ}, we instead may need to represent T₂ with an additional global phase as:

$${\tilde{T}}_{2} ( θ , ϕ ) = {e}^{- i \frac{θ}{2}} {T}_{2} ( θ , ϕ ) \qquad ( 11 )$$

where we use a single phase shift θ instead of a differential phase shift in the internal phase shift of the MZI. The fundamental function of the MZI is to be able “nullify” (minimize to zero) power in either of its output powers given any input vector. In mathematical terms, given any x, we should be able to generate an output of the form y=(y₁, 0). We can perform the nullification of y₂ for any MZI T₂(θ, ϕ) with inputs x₁, x₂:

$$θ = 2 arctan \vert \frac{{x}_{1}}{{x}_{2}} \vert \qquad ( 12 )$$

$$ϕ := - arg ( \frac{{x}_{1}}{{x}_{2}} ) ,$$

with the convention for θ, ϕ being internal and external phase shifters, shown in MZI 106, FIG. 1E.

### Vector Units

A vector unit may be used as a 1×N input vector generator or an N×1 output vector analyzer (the flipped version of the input generator). An N-vector unit is a “tree network” of N−1 splitters θ_{X} and N output phases ϕ_{X}, with the fully balanced binary tree and the maximally unbalanced linear cascade (diagonal line) as extreme cases (see FIG. 9B). An input generator generates optical modes representing any N-dimensional complex vector given a single input to the system up to a (nonphysical) global phase and can be either balanced or unbalanced as shown in FIG. 9C. Operated in reverse, the analyzer allows for the N−1 splitters to route all input light into a single port.

The overall mathematics can be represented in either vector or bra-ket notation as follows (where X† represents analysis and X represents generation):

$$x = X {e}_{1} \qquad ( 13 )$$

$$\vert x 〉 = X \vert 0 〉$$

$${X}^{†} \vert x 〉 = \vert 0 〉$$

The algorithm used to set up an output vector unit analyzer first establishes a path between the root MZI and all other vector unit MZIs (known as a topological order) such that all the light exits the output of the vector unit.

Experimentally, this can be achieved using self-configuration by minimizing the power (first sweeping ϕ and then sweeping θ) for N−1 open ports of the device to maximize output port power. All devices belonging to a given column can be programmed simultaneously (in parallel), so for binary tree architectures, this measurement can be done in [symbol] (log N) steps. In this work, however, since we use a camera for all photodetection measurements, this protocol can be relatively slow. Therefore, we instead use four measurements, with θ=π/2 and ϕ=0, π/2, π, 3π/2 to deduce the powers p₀, P_{π/2}, p_{π}, p_{3π/2T} and compute relative phase as arctan

$$( \frac{{p}_{3 π / 2} - {p}_{π / 2}}{{p}_{π} - {p}_{0}} ) .$$

This is shown in FIG. 9G.

Output detection can be made faster if necessary using homodyne coherent detection as shown in FIG. 9C where nominally 50 percent of the total input light is split into N waveguides and sent directly to the output of the matrix unit implementing U. In the analog domain this protocol uses only a single step. As with our self-configuration phase measurement protocol, it uses additional computation on the digital end to deduce the phase.

### Matrix Unit

The matrix unit 210, FIG. 2B, is any suitable arrangement of interferometers needed to represent a subset of unitary matrices in U(N); a universal (unitary) matrix unit can implement any unitary matrix in U(N). Examples of universal matrix units are triangular, rectangular, cascaded binary tree (which is more useful for quantum applications of this scheme, but can be represented classically). Such devices have [symbol] (N²) parameters: N(N-1)/2 MZIs with 2 phase shifters each θ_{U}, ϕ_{U} and N output phase shifters γ_{U}. Because multiplying by γ_{U} is an [symbol] (N) operation, all computation for-y (both forward and backward passes in the gradient computation is performed on the computer. In the protocol shown in FIGS. 9A-9G, we do not include any γ_{U} phase shifts due to the assumption that those computations are relatively inexpensive and can be fully accounted for off-chip.

The matrix unit is represented by an operator U that performs the following operation (in vector notation and bra-ket notation):

$$Ux = y \qquad ( 14 )$$

$$U \vert x 〉 = \vert y 〉 = Y \vert 0 〉$$

In vector notation, the relative phases given by

$$arg ( \frac{U x}{x} )$$

can be measured only up to an overall phase, so an additional measurement is used to measure this overall phase. In bra-ket notation, we typically can only ensure [symbol] 0|Y†UX|0 [symbol] =e^{iϕ0}, where ϕ₀ is some phase that depends on the effective overall pa feng h in the device, which is a function of all the phase shifts. In theory, we could figure out what this overall path length is by some [symbol] (N²) mathematical computation, but in practice, this can be measured directly in [symbol] (1).

### Reference Arm

Phase shifts in physical systems typically have no meaning without a reference, and this is ultimately crucial for designing and programming a photonic mesh. Adding a reference arm waveguide to an N-waveguide photonic mesh (mathematically, embedding all N-dimensional Hilbert space operations in an N+1-dimensional Hilbert space), an example of which has previously been demonstrated in coherent detection for complex optical neural networks.

Independent of reference arm placement, we treat the unitary operator (U embedded in N+1-dimensional Hilbert space as shown in FIG. 9D for N=4) as follows:

$$[ \begin{matrix} \\ y \\ \\ z\end{matrix} ] = [ \begin{matrix} & & & 0 \\ & U & & ⋮ \\ & & & 0 \\ 0 & … & 0 & 1\end{matrix} ] [ \begin{matrix} \\ x \\ \\ z\end{matrix} ] , \qquad ( 15 )$$

which allows us to calculate all phases in the matrix-vector multiplication relative to the phase shift in the added spatial mode (reference waveguide path length). We now can program and/or measure the full input and output x, y no matter what settings are used for U. Assuming a total power of 1, the constant phasor z here denotes a constant amplitude, such as 1/\sqrt{N+1} or whatever is deemed sufficient.

To properly measure phases for an N×N operation, we set the phase for the (N+1)th output of any vector unit as the “reference phase arm” (shown throughout FIGS. 9A-9G) and connect the reference arm to the waveguide where this phase is defined. If the magnitude of the Nth element is zero, we choose that the reference phase of the vector is also zero.

After storing the calibration curve of this reference phase in the computer, we can always set or measure this reference phase by maximizing power output of the reference arm MZI on the appropriate side of the device (e.g., as in the first step of FIG. 9F). This is generally a standard technique in phase detection in photonic circuits and similar schemes have been previously explored.

Note that in the case of homodyne detection of FIG. 9C, the math of the phase measurement is a bit different. A separate reference path is still provided, but instead of an analyzer with an additional reference dimension, the reference path is split and interfered at each output to determine the phase. This is a potentially faster and more “standard” method for measuring phases but the circuitry for bidirectional operation is a bit more complex.

FIGS. 9A-9G illustrate operation of 6×6 triangular MZI network. FIG. 9A shows a forward coherent matrix 4×4 multiplication 900 is performed by operating the edge diagonal MZI rows in a generator 902 and analyzer 904 (input/output vector unit) configuration and a fifth reference mode. FIG. 9B illustrates how a vector unit can be unbalanced or balanced; the latter is useful for operating rectangular meshes. FIG. 9C shows an alternative and likely faster approach using coherent detection or homodyne detection to measure amplitudes and phases (used in the scalability analysis). FIG. 9D shows coherent matmul operation performed by sending in an input based on the calibrated phase shifts and then performing self-configuration on the output fields including a reference path dimension; and FIG. 9E shows backward coherent matrix multiplication follows the same procedure but backwards. These plots are derived from actual measurements performed on the device and inset shading bars represent powers in the device corresponding to the waveguides shown. FIG. 9F shows how self-configuration proceeds by nullifying ports 5 through 2 in descending order. FIG. 9G shows how nullification is achieved using phase measurement rather than analog feedback minimization as this is more efficient in for this device configuration.

### Pseudocode

Here, we provide context for the pseudocode used to implement various algorithms for in situ backpropagation on our triangular mesh platform. Note that these approaches can be implemented on any matrix unit provided that the vector units can be used to generate any input fields. For output field generation, one can self-configure for backward and forward measurements on the existing vector units (FIG. 9F) or use a homodyne vector unit for measurement (FIG. 9G), the latter of which is preferable for efficient operation.

Our algorithm for in situ backpropagation uses the call g=INSITUGRADIENT(x, z). Here, g represents gradients taken over all η in the network (alg. 4). alg. 4 leverages Algs. 1, 2, 3 for generator/analyzer operation and the forward/backward steps for backpropagation. Note that some of the procedures such as READBACKWARD, SENDBACKWARD, READFORWARD, SENDFORWARD, PHASES do not have pseudocode, but these are explained elsewhere in this description.

As previously discussed, the VJP (or vector Jacobian product) function is often used in neural networks and autodifferentiation frameworks (e.g., JAX) to automatically carry out chain rule steps used in measuring gradients. As defined in alg. 4, a VJP calculation based on nonlinearity derivatives is performed in the digital domain since the nonlinearity itself is also performed in the digital domain. We have already defined VJP in the context of optical backpropagation (“optical VJP”) in the Methods section in terms of physical measurement; in general, nonlinear VJPs are more straightforward to compute digitally.

Physically computing nonlinear VJPs does not offer much benefit in the optical domain for our purpose (energy efficient computation) since the energy to define inputs and outputs is already [symbol] (N) in the digital-analog conversion which is also the complexity of an elementwise digital nonlinearity. However, there have been various efforts to develop nonlinearities where backward propagation approximates the derivative.

Finally, now that we have defined all of the gradient measurement pseudocode, we are ready to define the final training protocol, which we use throughout this description to achieve photonic in situ training. We define the full training set of Nₜᵣₐᵢₙ training examples as a Nₜᵣₐᵢₙ×N data matrix X and associated label set Nₜᵣₐᵢₙ×N_{label} Z which are input into alg. 5.

Note that there are two nontrivial implementations in alg. 5: the Adam optimizer and minibatch training protocols. In practice, we leverage autodifferentiation packages to implement much of this needed functionality (e.g., we use JAX's optim package for the Adam optimizer). We choose a minibatch size of 1 implementing a purely “stochastic” update which does not average over many training examples. In our particular case, this helps to avoid errors in the gradient which as we have found can accumulate over a large batch of training examples for this particular problem (FIGS. 8A-8J)), although FIG. 2A-2F and FIGS. 11A-11D do not suffer from this issue. This further underscores the importance of reducing gradient error to enable minibatch training used for a photonic advantage to reduce the update frequency and thus power in the training method (as we will later discuss).

Additionally, further experimental work is warranted to explore analog adaptive update schemes that store previous gradients in analog memory (via sample-and-hold); we provide explicit proposals for such schemes in FIGS. 10A-10F, with a partial experimental demonstration in FIGS. 11A-11D. This would be important in cases where a purely analog update is used; otherwise a potentially more energy-consuming digital subtraction update would be needed to compute the history aggregation vector h at each step of the optimization.

Algorithm 1 VECTOR UNIT PHASE CONVERSION

| 1: | function VEC2PHASE(x) | [symbol] Fig. 9F |
|---|---|---|
| 2: | require x ∈ [symbol] ^{N}, \|\|x\|\| = 1. | |
| 3: | for m ∈ [1, 2, . . . N − 1] do | |
| 4: | ${ϕ}_{m} ← - arg ( \frac{{x}_{1}}{{x}_{2}} )$ | [symbol] Fig. 9G |
| 5: | ${θ}_{m} ← 2 arctan \vert \frac{{x}_{1}}{{x}_{2}} \vert$ | [symbol] nullify at m + 1 |
| 6: | ${x}_{m} ← {e}^{i {ϕ}_{m}} sin \frac{{θ}_{m}}{2} {x}_{m} + cos \frac{{θ}_{m}}{2} {x}_{m + 1}$ | |
| 7: | xₘ + 1 ← 0 | |
| 8: | end for | |
| 9: | return θ, ϕ | |
| 10: | end function | |
| 11: | function PHASE2VEC(θ, ϕ) | |
| 12: | require θ ∈ [0, π]^{N}. | |
| 13: | require ϕ ∈[0, 2π)^{N}. | |
| 14: | x = [1, 0, ... 0] ∈ [symbol] ^{N} | |
| 15: | for m ∈ [1, 2, . . . N − 1] do | |
| 16: | $( \begin{matrix}{x}_{m} \\ {x}_{m + 1}\end{matrix} ) ← {{\tilde{T}}_{2} ( {θ}_{m} , {ϕ}_{m} )}^{T} ( \begin{matrix}{x}_{m} \\ {x}_{m + 1}\end{matrix} )$ | |
| 17: | end for | |
| 18: | return x exp(−i arg(x_{N})) | [symbol] Zero phase for x_{N} |

| | |
|---|---|
| 19: | end function |
| 20: | function NORM(X) |
| 21: | require X ∈ [symbol] ^{M×N}. |
| 22: | x₁, x₂, . . . x_{M} ← X. |
| 23: | for m ∈ [1, 2, . . . M] do |
| 24: | qₘ ← \|\|xₘ\|\| |
| 25: | end for |
| 26: | return q |
| 27: | end function |

Algorithm 2 FORWARD STEP

| 1: | function MESHFORWARD(x; θ, ϕ, γ, q) | |
|---|---|---|
| 2: | require x ∈ [symbol] ^{N}. | |
| 3: | require θ ∈ [0, π]^{N(N-1)/2}. | |
| 4: | require ϕ ∈ [0, 2π)^{N(N-1)/2}. | |
| 5: | require γ ∈ [0, 2π)^{N}. | |
| 6: | x ← x/\sqrt{q} | [symbol] rescale/normalize |
| 7: | x ← [x·\sqrt{1 − 1/N}, \|\|x\|\| \sqrt{1/N}] | [symbol] add reference path |
| 8: | θ_{X}, ϕ_{X} = VEC2PHASE(x) | [symbol] off-chip |
| 9: | i ← 1 | |
| 10: | p ← 0 | |
| 11: | w ← SEND FORWARD(θ_{X}, ϕ_{X}) | [symbol] on-chip |
| 12: | for n ∈ [1, 2, . . . N − 1] do | [symbol] on-chip |
| 13: | for m ∈ [1, 2, . . . N − n] do | |
| 14: | $( \begin{matrix}{ω}_{m} \\ {ω}_{m + 1}\end{matrix} ) ← {\tilde{T}}_{2} ( {θ}_{i} , {ϕ}_{i} ) ( \begin{matrix}{ω}_{m} \\ {ω}_{m + 1}\end{matrix} )$ | [symbol] forward prop |
| 15: | measure p_{θ}_{ᵢ}, p_{ϕ}_{ᵢ} | [symbol] detect phase shift powers |
| 16: | i ← i + 1 | |
| 17: | end for | |
| 18: | end for | |
| 19: | θ_{Y}, ϕ_{Y} = READFORWARD(w) | [symbol] self-configuration |
| 20: | y ← PHASE2VEC(θ_{Y}, ϕ_{Y}). e^{iγ} | [symbol] off-chip |
| 21: | y ← y_{:N}/\sqrt{1 − 1/N} | [symbol] remove reference |

| | |
|---|---|
| 22: | return \sqrt{q}y, qp |
| 23: | end function |
| 1: | function MESHFORWARDBATCH(X; θ, ϕ, γ, q) |
| 2: | x₁, x₂, . . . x_{M} ← X |
| 3: | for m ∈ [1, 2, . . . M] do |
| 4: | yₘ, pₘ < MESHFORWARD(xₘ, θ, ϕ, γ, qₘ) |
| 5: | end for |
| 6: | Y ← y₁, y₂, . . . y_{M} |
| 7: | P ← p₁, p₂, . . . p_{M} |
| 8: | return Y, P |
| 9: | end function |

Algorithm 3 BACKWARD STEP

| 1: | function MESHBACKWARD(y; θ, ϕ, γ, q) | |
|---|---|---|
| 2: | require y ∈ [symbol] ^{N}. | |
| 3: | require θ ∈ [0, π]^{N(N-1)/2}. | |
| 4: | require ϕ ∈ [0, 2π)^{N(N-1)/2}. | |
| 5: | require γ ∈ [0, 2π)^{N}. | |
| 6: | y ← y/\sqrt{q} | [symbol] rescale/normalize |
| 7: | y ← [y·\sqrt{1 − 1/N}, \|\|y\|\| \sqrt{1/N}] | [symbol] add reference path |
| 8: | θ_{Y}, ϕ_{Y} = VEC2PHASE(y*·e^{iγ}) | [symbol] off-chip |
| 9: | i ← N(N − 1)/2 | |
| 10: | p ← 0 | |
| 11: | w ← SEND FORWARD(θ_{Y}, ϕ_{Y}) | [symbol] on-chip |
| 12: | for n ∈ [1, 2, . . . N − 1] do | [symbol] on-chip |
| 13: | for m ∈ [1, . . . n] do | |
| 14: | $( \begin{matrix}{ω}_{m} \\ {ω}_{m + 1}\end{matrix} ) ← {{\tilde{T}}_{2} ( {θ}_{i} , {ϕ}_{i} )}^{T} ( \begin{matrix}{ω}_{m} \\ {ω}_{m + 1}\end{matrix} )$ | [symbol] back prop |
| 15: | measure p_{θ}_{ᵢ}, p_{ϕ}_{ᵢ} | [symbol] detect phase shift powers |
| 16: | i ← i + 1 | |
| 17: | end for | |
| 18: | end for | |
| 19: | θ_{X}, ϕ_{X} = READFORWARD(w) | [symbol] self-configuration |
| 20: | x ← PHASE2VEC(θ_{X}, ϕ_{X}) | [symbol] off-chip |
| 21: | x ← x_{:N}/\sqrt{1 − 1/N} | [symbol] remove reference |

| | |
|---|---|
| 22: | return \sqrt{q}x, qp |
| 23: | end function |
| 1: | function MESHFORWARDBATCH(Y; θ, ϕ, γ, q) |
| 2: | y₁, y, . . . y_{M} ← Y |
| 3: | for m ∈ 1, 2, . . . M do |
| 4: | xₘ ← MESHBACKWARD(yₘ, θ, ϕ, γ, qₘ) |
| 5: | end for |
| 6: | X ← x₁, x₂, . . . x_{M} |
| 7: | P ← p₁, p₂, . . . p_{M} |
| 8: | return X, P |
| 9: | end function |

Algorithm 4 In SITU BACKPROPAGATION

| 1: | function INSITUBACKPROP(X, Z) | [symbol] Inference/forward + backprop/backward |
|---|---|---|
| 2: | require X ∈ [symbol] ^{M×N}. | |
| 3: | require Z ∈ [symbol] ^{M×N}^{_{label}}. | |
| 4: | θ, ϕ, γ ← PHASES(U⁽ [symbol] ⁾) | [symbol] phases of mesh [symbol] |
| 5: | X⁽¹⁾ ← X | |
| 6: | for [symbol] ∈ 1, 2, . . . L do | [symbol] inference task |
| 7: | [symbol] ← MESHFORWARDBATCH( [symbol] , θ, ϕ, γ, NORM( [symbol] )) | |
| 8: | [symbol] ← [symbol] | |
| 9: | end for | |
| 10: | ${Y}_{adj}^{( L )} ← \partial c ( {X}^{( L + 1 )} , Z ) / \partial Z ⊳ or \partial ℒ / \partial z {\vert}_{x , z}$ | |
| 11: | for [symbol] ∈ L, L − 1, . . . 1 do | [symbol] backprop task |
| 12: | ${X}_{adj}^{( ℓ )} ← MESHBACKWARDBATCH ( {Y}_{adj}^{( ℓ )} , θ , ϕ , γ , NORM ( {Y}_{adj}^{( ℓ )} ) )$ | |
| 13: | fᵥⱼₚ ← VJP (f⁽ [symbol] ⁾ | [symbol] autodiff, JAX/Haiku |
| 14: | ${Y}_{adj}^{( ℓ - 1 )} ← {f}_{vjp}^{( ℓ )} ( {Y}^{( ℓ )} , {X}_{adj}^{( ℓ )} )$ | |
| 15: | end for | |
| 16: | $return {X}^{( \cdot )} , {X}_{adj}^{( \cdot )} \cdot$ | [symbol] X^{(·)} denotes all layers. |
| 17: | end function | |
| 1: | function INSITUGRADIENT(X, Z, type) | [symbol] Full gradient |
| 2: | ${X}^{( \cdot )} , {X}_{adj}^{( \cdot )} ← INSITUBACKPROP ( X , Z )$ | |
| 3: | $3 : {F}_{\pm }^{( \cdot )} ← {X}^{( \cdot )} ∓ i {X}_{adj}^{( \cdot )}$ | |
| 4: | parfor [symbol] ∈ 1, 2, . . . L do | [symbol] Parallel gradient across all layers |
| 5: | if type = analog then | |
| 6: | [symbol] = maxNORM( [symbol] ) | |
| 7: | . . . , [symbol] = MESHFORWARDBATCH( [symbol] , θ, ϕ, γ, [symbol] ) | |
| 8: | . . . , [symbol] = MESHFORWARDBATCH( [symbol] , θ, ϕ, γ, [symbol] ) | [symbol] electronic integration/LP filter |
| 9: | ${p}_{\pm }^{( ℓ )} = {{\sum }_{m = 1}^{M} [ {P}_{\pm }^{( ℓ )} ]}_{m} / 4$ | |
| 10: | [symbol] | [symbol] analog subtraction/HP filter |
| 11: | else | |
| 12: | . . . , [symbol] = MESHFORWARDBATCH( [symbol] , θ, ϕ, γ, NORM( [symbol] )) | |
| 13: | . . . , [symbol] = MESHFORWARDBATCH( [symbol] , θ, ϕ, γ, NORM( [symbol] )) | |
| 14: | $… , {P}_{adj}^{( ℓ )} = MESHFORWARDBATCH ( {X}_{adj}^{( ℓ )} , θ , ϕ , γ , NORM ( {X}_{adj}^{( ℓ )} ) )$ | |
| 15: | ${g}^{( ℓ )} = {{\sum }_{m = 1}^{M} [ {P}_{+}^{( ℓ )} - {P}^{( ℓ )} - {P}_{adj}^{( ℓ )} ]}_{m} / 2$ | [symbol] digital subtraction |
| 16: | end if | |
| 17: | end parfor | |
| 18: | return g^{(·)} | [symbol] digital subraction |
| 19: | end function | |

Algorithm 5 IN SITU BACKPROPAGATION TRAINING

| 1: | function INSITUMINIBATCHTRAIN(X, Z, M) | |
|---|---|---|
| 2: | require X ∈ [symbol] ^{Ntrain×N}. | |
| 3: | require Z ∈ [symbol] ^{Ntrain×Nlabel}. | |
| 4: | h ← 0 | [symbol] tracks gradient history |
| 5: | for t ∈ [1, 2,...T] do | [symbol] on-chip |
| 6: | randomly sample Xₜ, Zₜ from X, Z. | |
| 7: | require Xₜ ∈ [symbol] ^{M×N}. | |
| 8: | require Zₜ ∈ [symbol] ^{M×Nlabel}. | |
| 9: | gₜ ← INSITUGRADIENT(Xₜ, Zₜ) | [symbol] minibatch average |

| | |
|---|---|
| 10 | δη, h ← OPTIMIZER (gₜ, h) |
| 11: | end for |
| 12: | end function |

### Analog Update

### Equivalence of Digital and Analog Update

Here, we prove the equivalence of our new analog measurement proposal and the numerically evaluated gradient [symbol] (x_{η},x_{η,adj}) which has previously been shown to be equivalent to the digital subtraction update.

We assume the update is to be applied at phase shifter q and we measure fields x_{η} when inputting x alone and

$$i {x}_{adj , η}^{*} {e}^{i ζ}$$

when inputting

$${x}_{adj}^{*}$$

alone. The resulting gradient is given by tracking the power at phase shifter η,

$${p}_{η} ( ζ ) = x - i {x}_{adj}^{*} {e}^{i ζ}$$

for ζ=, π(p_{η,+}=p_{η}(0), p_{η,-}=p_{η}(π)) and calculating the gradient update in the analog domain:

$${p}_{η} ( ζ ) = {\vert {x}_{η} \vert}^{2} + {\vert {ix}_{adj , η}^{*} {e}^{i ζ} \vert}^{2} - 2 ℛ ( {ix}_{η} {x}_{adj , η}^{*} {e}^{i ζ} ) \qquad ( 16 )$$

$${p}_{η} ( 0 ) - {p}_{η} ( π ) = - 4 ℛ ( {ix}_{η} {x}_{adj , η}^{*} ) = 4 ℐ ( {x}_{η} {x}_{adj , η} )$$

$$\frac{\partial ℒ}{\partial η} = ℐ ( {x}_{η} {x}_{adj , η} ) = \frac{{p}_{η} ( 0 ) - {p}_{η} ( π )}{4} .$$

Ultimately, we need to convert this power to a voltage to compute (p_{η}(0)−p_{η}(π))/4 in the analog domain, and this voltage can be applied to the phase shifter as a gradient update. The way this is achieved is to convert the power to current (using photodiode) and the current to a voltage via a transimpedance amplifier (TIA) with gain R_{f}, typically 100 kΩ. To achieve the necessary learning rates in an optimization and to correct for any tap coupling variances and optoelectronic component variation, this transimpedance gain is ideally tunable.

### Analog Update Protocol

Now that we have shown the equivalence of the digital and analog updates, we discuss the physical implementation of the analog gradient update implementation in hybrid photonic neural networks. In the experiment discussed earlier (FIG. 2A-2F), we performed the analog electronic operations in the digital domain so our experiment amounted to a digital proof-of-concept of our analog optoelectronic gradient update scheme.

The analog signal processing to implement the gradient updater involves two stages (1) analog subtraction stage and (2) an update stage. The update stage has a gated integrator implemented using a summing amplifier feedback (with gate width specified in the original signal synchronized to ζ(t)) with a sample-and-hold update trigger. The analog subtraction stage can be implemented in one of two ways. The first way, which is more compatible with single-example updates and is more accurate in the presence of noise-dominated error, is to directly measure the amplitude of a periodic photodiode response due to toggling the adjoint phase (repeatedly (as in FIG. 2C). The output of the summing amplifier is the gradient that can be directly applied as a control signal to the sample-and-hold phase shifter voltage. This is shown in more detail in FIG. 10A and the analog response is assessed in FIG. 10E. Another more complex but faster scheme for the analog subtraction is shown in FIG. 10B, which accommodates batched data used in our later energy analysis, where a sample-and-hold scheme stores a single instance of the sum and difference signals which are then fed into a differential amplifier with unity gain to implement an analog subtraction.

To perform a batch gradient update, we sum the contributions of batch size M inputs to the gradient and aggregate them into a single update, using the property of linearity of the gradient. While sending the batch inputs at the switching frequency of the input modulators (1 GHz), the update can be achieved in the scheme of either FIG. 10A or FIG. 10D by modifying the timing of the sample-and-hold update trigger, the reset time of the analog subtraction integrator, and increasing the (toggle time to match that of the batch input frequency, which gives M⁻¹ GHz. As a bonus, the reduction in the necessary sampling time of the photodetector (which is now simply adding contributions to the power from many inputs) means that the signal-to-noise ratio is ultimately increased, which could improve gradient update precision. Thus in the analog domain, stochastic minibatch gradient descent updates provide unique and important advantages not afforded by simple stochastic gradient descent with M=1.

As briefly mentioned earlier, constant scaling factors used for gradient updates may be reflected in the analog signal processing, e.g., feedback resistance in the TIA or bias voltage (which adjusts the gain G in a avalanche photodiodes). Note that during in situ backpropagation, the forward- and backward-propagating optical signals in each of the photonic mesh accelerator chips are normalized to the same power. The computer stores the actual vector norms of the input and output vectors x, x_{adj} as P, P_{adj} as defined also in alg. 5. The sum vector

$$x - {ix}_{adj}^{*}$$

is trickier to rescale. In the analog update case, the input light is split equally into two input vectors implementing the normalized x,

$${x}_{adj}^{*}$$

and then interfered to yield the (lossy) vector sum

$$( x - i {x}_{adj}^{*} ) / \sqrt{2}$$

as shown in FIG. 2B. To recover the gradient, all that is needed is to multiply by a consistent normalized factor (discussed in algs. 2 and 3). This can be applied as a uniform scaling factor to all gradient updaters used to determine the gradient in the analog domain. This is the only scaling factor that varies according to the training example sent through the device; all other scaling factors can be grouped in with the overall learning rate of the system. Measured and predicted gradient measurements show good agreement as in FIG. 10C and FIG. 2A-2F.

### Experimental Demonstration

As previously briefly described in Methods, we demonstrated a proof-of-concept all-analog update scheme on a single phase shifter using a single MZI to vary the power at a phase shifter η in our mesh (FIG. 11A). In our scheme, we implemented a minimal training example optimizing a single phase shifter to minimize output power at a fiber photodetector, using an output MZI (with controllable internal arm phase γ) to switch between inference setting and gradient update setting (0<γ<π(on-bar/cross) for inference and γ=π (bar) for gradient update). We implemented the scheme with an external analog circuit and bulk electronic components (FIG. 11B, a minor modification of FIG. 10B).

Based on this simple concept, we ran two experiments:
1. We first performed gradient measurement of a single phase shifter η, to demonstrate gradient measurement along various points from 0 to 2π for single-example gradient-based training. We chose the value θ=π/3, ϕ=γ=π/4 for the inference part of this example. Based on these measurements, we measured the gradient at each point along the curve using our analog measurement scheme and computed values for x±based on the error function [symbol] , equal to the power measured at the top port of FIG. 11A. The measured gradient is consistent with the theoretical gradient for all batches as shown in FIG. 11C.
2. We then performed gradient error analysis of r, given random sum and difference inputs (using now only the bottom panel of FIG. 11A) defined at batch sizes of M=1, 2, 4.

As shown in FIG. 11D, we found the discrepancy between the measured gradient and theoretical gradient remained small (on par with our digital gradient measurement errors), demonstrating the effectiveness of our scheme.

FIGS. 10A-10F illustrate a full analog backpropagation scheme. FIG. 10A shows a conceptual analog gradient update flow for single training examples, which updates phase shifter r, based on power signal p_{η}(ζ), which varies according to adjoint phase ζ that is toggled multiple times. FIG. 10B shows an alternative method, used in energy scaling analysis, using just one phase shift toggle cycle. FIG. 10C shows the location of the circuit in the optimized version of our protocol in a hypothetical CMOS co-integrated photonic-electronic implementation. FIG. 10D is a timing diagram for various switches to implement the analog subtraction protocol, with signals annotated in FIG. 10A, 10B. “Adjoint phase” and “grad” timing signals coincide because the timing of the gradient update matches that of the toggle of adjoint phase ζ as defined in FIG. 2A-2F. FIG. 10E are graphs of a camera-based high-pass analog gradient demonstration far from or close to convergence from FIGS. 10A-10F (σ_{θ,ϕ}=1, 0.2 respectively). The AC power p_{η} measured across all grating tap monitors decrease in gradient magnitude near convergence. FIG. 10F is a graph showing that tap coupling strength to ensure roughly equal power goes to all photodetectors appears to be small unless the component losses get too big α>0.2.

FIGS. 11A-11D illustrate an analog backpropagation demonstration. FIG. 11A shows a modified analog backpropagation scheme using a large resistance for transimpedance, an integrator with sum and difference sample-and-hold modules, and a differential amplifier outputting the gradient. The photonic circuit was operated in either inference or gradient mode by changing the value of γ, the first input MZI was used to set all input, sum and difference signals. FIG. 11B shows a circuit board used in the demonstration, including the +12V op-amp supply and op-amps (for integrators and sample-and-holds). FIG. 11C is a graph showing good agreement between measured and predicted gradients for r/along the error function contour for [symbol] (green). FIG. 11D are graphs of elementwise gradient comparisons that show good agreement, on-par with on-chip camera gradient measurements; we include a normalized comparison involving dot product of gradients normalized over all trials for each batch size.

### Photonic Advantage Versus Accuracy Tradeoff

As discussed earlier, there is an important tradeoff to be investigated between accuracy, defined for a specific problem, and photonic advantage, defined in terms of latency (operations per second or OPS) and energy efficiency (energy per operation or fJ/OP). Our demonstration is proof that photonics can be used to implement backpropagation in the physical domain, but it is not fully optimized for a commercial setting due to the use of an IR camera (which may be useful in free space implementation of our protocol), a movable stage (the key bottleneck preventing timely gradient updates), and thermal phase shifters (which are not energy efficient, using roughly 50 mW of power consumption per phase shifter). Here, we will discuss the photonic energy scaling for an optimized photonic neural network architecture based on rectangular photonic meshes (rather than the triangular mesh used in this work) coupled with binary tree analyzers and generators, which promise lower optical depth (N+2 log N versus 2N−3 for triangular) and better loss balancing to simplify the modelling.

The first key point is that the systematic and noise errors in the PNN must be sufficiently small such that the learning converges to a value comparable to what might be achieved on a digital platform. One notable example is the need for transimpedance amplifiers (TIAs) connected to the phase shifter gradient feedback loops needed for the analog gradient update, which can amplify the voltage signal at the expense of higher energy consumption. Another tradeoff is the increase in batch size, which helps reduce the energy consumption by making gradient updates less frequent per operation (less usage of the TIA). Although this in some scenarios can result in an increase in the gradient error (FIG. 8H), this is not always necessarily the case (FIGS. 2F, 4), and larger batch sizes are generally known to help the training generalize better and avoid overfitting because they capture a larger variety of the data at each update.

FIGS. 12A-12D illustrate a hierarchical analysis of in situ backpropagation energy consumption. FIG. 12A shows various components (modulators, switches, ADCs, DACs, TIAs, etc.) involved with energies provided in Table 1. FIG. 12B shows the subtasks (I/O prep, optoelectronic conversions, gradient update, Table 2) and final tasks (inference and training, Table 3). FIG. 12C is a graph of batch sizes (M) and number of modes (N) needed for photonic advantage in inference (4×, 2×, 1× contours based on the 100 fJ digital FLOP energy estimate, with the high bit precision particularly needed for gradient measurement). FIG. 12D is a graph of batch sizes (M) and number of modes (N) needed for photonic advantage in training via in situ backpropagation over the digital alternative.

### Latency

Although the main calculation is to show the energy efficiency of our approach, we will briefly discuss the latency and memory requirements of our system. The system latency is limited by the speed of the fastest modulators used to define the inputs (e.g., lithium niobate or barium titanate) which are assumed to operate continuously at about 1 GHz during the operation of the device upon the arrival of batched data prepared on the computer. Transit time of a single input x (rather than a batch of data) will generally take less time (1 ns or less depending on the length of the optical propagation, generally several centimeters) which is on the order of the system latency. However, the predominant operational mode for a photonic advantage must be to operate on batches of data which significantly exceed the propagation time of the optical signals at sufficiently large batch sizes M>1 (FIGS. 10A-10F). This is particularly relevant for training because single-example training (explored in this work) can place a larger burden on the gradient update circuit energy consumption, so batch (or “minibatch”) training is recommended in this case.

### Error Considerations

Assuming component efficiencies for a 1 GHz input sample rate, we calculate the energy of training and inference modes of operation up to N=64 with batch size M. For corresponding simulations, we define the various contributors to error (systematic, numerical, and noise), finding that much of the error results from noise at during the photodetection in the gradient update stage. A key assumption we make in our components is that the scaling of the power usage of those components is proportional to the sampling frequency; if the sampling frequency (i.e., 1 GHz) is lower than the specification reported for the component, we rescale the energy specification for 1 GHz as shown in Table 1.

### Bit Precision and Digital Input Control

We use 8 bit precision for defining phase shifter voltages. A key design consideration in our system is the usage of digital-to-analog converter, transimpedance amplifier, and the analog-to-digital converter, electronic components that consume the majority of energy per operation as we find in Table 1. Because the E_{DAC} consumes the most energy, we can convert all phase settings to 8-bit digital signals that are directly used to set phase shifts partitioned into a bitwise encoding, known as a “digital control phase shifter.” In a digital control phase shifter, we can have 8 concatenated phase shift regions, where each phase shift is twice as long as the previous one up to 8 components and the total length matches that of a 2π phase shift. This increases the number of contacts but should not increase significantly the footprint of the phase shifter (as shown in FIG. 12A), and there are already a large numbers of contacts used to control the other phase shifters in the mesh (N² in the mesh compared to 16N for digital input control) so it's mostly a matter of design complexity. When using the analog update scheme, this avoids the need for digital-to-analog converters altogether, aside from setting the phase shifters within the mesh, which incurs a relatively small initialization cost. Analog-to-digital conversion (ADC), on the other hand, is used to evaluate nonlinearities on the computer; reducing the energy of ADCs is a key engineering challenge for photonic networks.

### Input-Output Preparation Dominates MVM

In our hybrid scheme, most of the computation is concentrated in sending in N input modes using modulators (just 16 fJ using the digital control phase shifter) and digital-analog converters and measuring the N output mode powers and amplitudes using photodetectors and 8-bit analog-digital converters (each taking energy E_{ADC}=1.38 pJ), and TIAs of which four each are used for homodyne phase measurement. Therefore a given matrix-vector product costs roughly MN·1.54 pJ per batch (M=1 for a single input), given that converting optical signals to the digital domain dominates the energy consumption for the photonic mesh. On the other hand, a digital electronic computer (e.g., CPU, GPU, or other ASIC) scales less favorably as it uses N² sequential operations (i.e., multiply-and-accumulate operations not possible to apply in parallel) to compute any given matrix-vector product. This ultimately scales less favorably for sufficiently large N.

### Digital Assumptions

We assume 100 fJ multiply and accumulate (MACs) in digital systems based on a number of factors including technology maturity and communication energy requirements. Including communication energies in typical digital electronic schemes can be tricky. In electronics that do not leverage optical interconnect technology architectures, a high amount of “locality”θ is desired and typical energies for communication result in 8-bit MAC energies of as high as 1 pJ/MAC (0.5 pJ/OP in our case). As predicted by Horowitz for 45 nm node technology, using Karatsuba multiplication, an operation in the complex domain (Gauss' method) can cost 3 multiplications (0.2 pJ each) and 5 additions (0.03 pJ each), consistent with our roughly 100 fJ equivalent per 8-bit OP number in Table 1 when dividing by 6 to get E_{OP}.

Our energy calculations generally deal with all the calculations in the digital domain needed for each stage of the protocol. Calculations of phases needed at the generator to send in inputs and calculations of the phases read out at homodyne detectors need to be done digitally as described in our pseudocode (e.g., algs. 2 and 3). The total number of operations can vary depending on the exact implementation; our rough estimate is 6E_{OP} for each of the MN total complex numbers, the equivalent of an elementwise multiplication.

Finally, an apples-to-apples comparison of digital architectures can be challenging in light of the fact that optical neural networks favor unitary matrix multiplication. For simplicity, we only assume complex matrix multiplication in the digital domain as a comparison, which uses 6 MN² total OPs, accounting for the 6 flops needed for a complex number multiply. The derivative is thus assumed to be equivalent to the forward and backward pass through a given layer, which accounts for two matrix multiplies or 12 MN² OPs.

### Transimpedance Amplifier and Analog Subtraction

Beyond inference tasks, the additional backward and sum steps used for in situ backpropagation adds additional energy contributions. In the optimized circuit, the analog update shown in FIG. 2A-2F uses N² optoelectronic units for energy-efficient operation, each of which is outfitted with the gradient updater circuit and transimpedance amplifier (TIA) shown in FIG. 10A consuming energy E_{grad} to measure p₀. The TIA is necessary because it sets the effective learning rate to be sufficiently high to change the voltage during the update step. The current at a given tap will be in μA on average, but since the SGD update may have learning rates of 1 or 2 and the phase shifter range may be up to 10 V (can be as low as 1 V for MEMS), the TIA will need to reach at least 50 to 60 dBΩ, which is plausible. Since photodiode sensitivity can be tuned by changed the bias voltage of the photodiode V_{b} (FIG. 10A), it is also worthwhile noting that the learning rate can actually be tuned as a hyperparameter addressed to each gradient update feedback loop.

### Digital Readout and Subtraction

In addition to TIAs, additional ADCs at each tap photodiode may be useful to optionally read the intermediate monitored powers onto a computer. These ADCs can be used for digital subtraction in the demonstration described earlier (“ADC” there could be considered the digital components in the IR camera reading out powers from tap gratings). The digital subtraction described in FIG. 1E can be convenient (though not necessary) in adaptive updates that store information about previous gradients (e.g., Adam in FIG. 2A-2F), but there are a couple of drawbacks. First, a digital update is less memory efficient since N² elements need to be stored to be able to run the “digital subtraction” computation in backpropagation. Additionally, the total energy consumption becomes dominated by additional analog-digital conversions used for digital subtraction calculations. Our analog update, on the other hand, does not require such expensive conversions. There are scenarios where it may make sense to leverage ADCs and DACs for periodic monitoring and reinitialization of phase shift voltages respectively (the latter of which is already a part of the analog update stage in FIG. 10A, 10D). Because this monitoring and reinitialization is may be needed at the beginning or end of training on data, this should not consume a large percentage of the total training energy consumption.

### Wall Plug Efficiency and Optical Power

Next, we consider the total optical power budget, which begins to dominate at sufficiently large N due to exponential loss scaling of the components. If we distributed a high power laser evenly to power a large number of subdies in a given optical accelerator chip (implementing many photonic meshes necessitated by large PNN architectures), we should be able to achieve sufficiently high wall plug efficiencies (up to 45%). For instance a 1 W laser could be distributed to roughly 16 subdies implementing 64×64 photonic MVMs, satisfying our condition for roughly 64 mW (1 mW per mode) of total power per chip in Table 1. Since wall plug efficiencies can vary but can be on the same order as the optical power in the system, we will primarily consider the total optical power rather than electrical power required.

### Phase Shifters

A final energy consideration is the phase shift modulation. These voltage-controlled modulators may be controlled by thermal actuation, microelectromechanical (MEMS) actuation, Pockels nonlinearity materials such as barium titanate (BTO) and lithium niobate, electro-optic modulation (common in commercial foundries), and phase-change materials. Of these options, MEMS actuation is among the most promising because unlike thermally actuated phase shifters, they cost no energy to maintain a given programmed state (“static energy”), dramatically improving the energy efficiency of operation compared to thermal phase shifters which constantly dissipate large amounts of heat. Additionally, the sample-and-hold scheme of FIGS. 10A-10F is highly compatible and useful for low-energy updates of MEMS phase shifters. Note also that the switching energy consumption of the MEMS phase shifter can be in less than a picojoule, comparable to the energy consumption of the gradient update amplifiers, so close to convergence the amplifiers will dominate energy consumption of the update due to small voltage changes in the phase shifters. Additionally, unlike phase change materials, MEMS phase shifters use CMOS materials such as silicon or silicon nitride. Finally, such devices can be designed to operate linearly with voltage which ensures that the gradient update applied to the voltage is the same as that of the phase shift without a calibration curve.

TABLE 1
Experimentally verified electronic component energies
and symbols given 1 GHz clock (with references).

| | | | | Sample | | Energy, | | |
|---|---|---|---|---|---|---|---|---|
| Component | Symbol | Power | | freq. | | 1 GHz | | Ref. |
| Modulator | E_{mod} | 1 | μW | 1 | GHz | 1 | fJ | |
| Switch | E_{sw} | ≤1 | μW | 1 | GHz | ≤1 | fJ | |
| Transimpediance | E_{TIA} | 7 | mW | 10 | GS/s | 700 | fJ | |
| amp. | | | | | | | | |
| Digital-to-analog | E_{DAC} | 26 | mW | 5 | GS/s | 5 | pJ | |
| (8-bit) | | | | | | | | |
| Analog-to-digital | E_{ADC} | 1.73 | mW | 1.25 | GS/s | 1.38 | pJ | |
| (8-bit) | | | | | | | | |
| OP (8-bit) | E_{OP} | N/A | | 1 | GHz | ≥100 | fJ | |
| Per-mode optical | E_{mode} | 1 | mW | 1 | GHz | 1 | pJ | N/A |
| power | | | | | | | | |

Note
that when using digital control phase shifts, E_{DAC} = 0 and E_{mod} is 16× larger. OPS and MACs generally do not consume most of the energy of a digital processor (at low fJ energies, much of the energy is in communication), hence we use ≥100 fJ, provided for 45 nm CMOS, with 100 fJ as a conservative estimate for comparison.

TABLE 2
Energy contributions for specific tasks performed by a rectangular
photonic mesh (unitary matrix multiply) for batch size
M and number of inputs N.

| Subtask | Symbol | Unit Energy | Batch Multiplier |
|---|---|---|---|
| Input modulators | Eᵢₙ | 2E_{mod} + 2E_{DAC} | MN |
| Output detectors | Eₒᵤₜ | 4E_{TIA} + 4E_{ADC} | MN |
| Gradient update | E_{grad} | 2E_{TIA} + 10E_{sw} | 2N² |
| Digital MVM | E_{MVM,dig} | 6E_{OP} | MN² |
| Digital nonlinearity | E_{nl,dig} | 6E_{OP} | MN |
| Optical nonlinearity | E_{nl,alg} | Eₙₗ | MN |
| I/O preparation | Eᵢₒₚᵣₑₚ | 6E_{Op} + E_{mode} | MN |

TABLE 3
Energy formula for each stage

| Task | Symbol | Energy formula |
|---|---|---|
| Digital MVM | E_{MVM,dig} | E_{MVM,dig} |
| In situ MVM | E_{MVM,alg} | 2Eᵢₒₚᵣₑₚ + Eᵢₙ + Eₒᵤₜ |
| Digital VJP/grad | E_{grad,dig} | 2E_{MVM,dig} |
| In situ VJP/grad | E_{grad,alg} | 2E_{MVM,alg} + 2Eᵢₒₚᵣₑₚ + 2Eᵢₙ + |
| | | Eₒᵤₜ + E_{grad} |

TABLE 4
Final tabulated energy scaling evaluation for each task by component. For
inference, the key idea is the [symbol] (M N) scaling in OPs versus [symbol] (N²)
digital alternatives. For training, batch processing is the key to save
in energy since the gradient update complexity is [symbol] (M N + N²)
when updating phase shift values versus the expensive digital alternative.

| Task | Symbol | E_{OP} | E_{mod} | E_{DAC} | E_{ADC} | E_{TIA} | E_{mode} |
|---|---|---|---|---|---|---|---|
| Digital | E_{MVM, dig} | 6M N² | 0 | 0 | 0 | 0 | 0 |
| MVM | | | | | | | |
| In situ | E_{MVM, alg} | 12M N | 2M N | 2M N | 4M N | 4M N | 2M N |
| MVM | | | | | | | |
| Digital | E_{grad, dig} | 12M N² | 0 | 0 | 0 | 0 | 0 |
| VJP/grad | | | | | | | |
| In situ | E_{grad, alg} | 36M N | 6M N | 6M N | 8M N | 8M N + | 6M N |
| VJP/grad | | | | | | 4N² | |

TABLE 5
Reasonable parameters to evaluate Si-Ge avalanche photodiode (APD)
noise performance signal-to-noise ratio (SNR) with indicators
of contributions from this work and others.

| Parameter | Symbol | Values | Ref. |
|---|---|---|---|
| Responsivity | [symbol] | 0.85 A/W | |
| Dark current | I_{d} | 40 nA | |
| Sampling frequency | Δf | ≤1 GHz | this work |
| TIA feedback resistance | R_{f} | 3 kΩ | this work |
| Noise figure | Fₙ | 1.5 | |
| APD multiplication | M | 10 | |
| Excess noise factor | k_{A} | 0.05 | |
| Received optical power | P | 1 μW | this work |
| Received photocurrent | I(P) | 8.5 μA | this work |
| TIA min input-referred noise, 1 GHz | I_{TIA} | 0.32 μA | |

Note
that photodiode numbers are provided for experimental parameters for measurements given ~1310 nm input power, not the 1550 nm used in this work, but we assume this is a sufficient comparison as we simply aim to give a reasonable performance projection.

TABLE 6

| Assumed photonic parameters for a rectangular | |
|---|---|
| photonic mesh. | |
| Parameter | Desired values |
| Total input power (P) | 0.5N mW |
| Loss per MZI (α) | 0.2 dB |
| Optical depth (C) | 2N |
| Average tap power (pₜ) | 0.5 μW |

### Random Noise and Systematic Error Modelling

Our simulations show that random error (e.g., noise) and systematic error (e.g., loss variance and beamsplitter error) in the photonic meshes adversely affect the performance of in situ backpropagation and are a likely explanation for the nonideal convergence behavior observed in our experiments. Here, we lay the groundwork for these simulation experiments to evaluate the impact of random noise and systematic error on the performance of the backpropagation training, specifically the achieved optimized value. The goal is to find a regime of errors that ensure minimal to no impact on training accuracy, which allows in situ backpropagation to fairly achieve energy efficiency advantage without any sacrifice in performance. More importantly, we would like to explore this tradeoff at relatively large scale, e.g., N=64, where noticeable energy efficiency advantages can be found, which motivates our selection of the MNIST task for our simulations.

First, let us consider systematic error. For input and output detection, a major source of error is in the phase detection at the input and output of the mesh, which generally depends on the mechanism used to measure the phase. The homodyne mechanism of FIG. 9C can help to reduce these errors because the detection mechanism relies simply on a single column of independently acting beamsplitters. Another source of systematic error is loss variation, which involves optical signals entering modes that are not accounted for by the inputs and outputs at the analyzer and generator of the device (e.g., scattering or absorption-related losses). While balanced loss can be accounted for by a simple scaling, loss variation results in differing amounts of light being scattered or absorbed in each MZI which cannot be easily accounted for in this way. Accordingly in our simulations, we model loss imbalance that varies randomly across the MZI arms in the photonic mesh. The only remaining systematic error other than loss imbalance and systematic errors in input and outputs is the beamsplitter splitting errors and in-mesh phase errors, which do not affect the gradient measurement because they do not cause light to leave the system and thus retain the assumptions of the gradient calculation discussed earlier.

The dominant source of error is likely to reside in the noise contributions to integrated photodetectors placed at the power monitoring taps which connect to the feedback update mechanisms during the backpropagation. The photodiodes integrated in an active photonic platform could be in the form of a Ge-on-Si (germanium on silicon) or a more fabrication-intensive InGaAs (indium gallium arsenide) photodiode stack, but generally avalanche photodiodes (APDs) on a SiGe silicon platform provide sufficient performance in terms of noise and gain-bandwidth product.

Having determined the typical average power we might expect at the tap monitors, we compute the signal-to-noise-ratio (SNR) at the photodetectors which is relevant for the gradient update. To ensure sufficiently high signal-to-noise ratio given typical power levels at the tap monitors, these photodiodes are implemented as integrated avalanche photodetectors (APDs) containing a germanium receiver and silicon multiplier, which achieves high bandwidth-gain product. In this regime, we consider both thermal noise and photon shot noise, and we report on the signal-to-noise ratio and the related noise constant sₜₐₚ as an input to the simulation model:

$$\begin{matrix}SNR ( P ) := \frac{〈 {I}^{2} 〉}{{σ}_{noise}^{2}} \approx \frac{〈 {I}^{2} 〉}{{σ}_{th}^{2} + {σ}_{s}^{2}} \\ = \frac{{ℛ}^{2} {P}^{2} {M}^{2}}{\begin{matrix}4 {kTF}_{n} Δ f / {R}_{f} + 2 {qM}^{2} {F}_{A} ( M ) \\ ( ℛ P + {I}_{d} ) Δ f\end{matrix}} \approx \frac{ℛ P}{2 {qF}_{A} ( M ) Δ f} \\ {s}_{tap} := {σ}_{noise} / \sqrt{P} \approx \sqrt{2 {qF}_{A} ( M ) Δ f / ℛ}\end{matrix} , \qquad ( 17 )$$

where F_{A}(M)=k_{A}M+(1−kA)(2−1/M). We list the parameters used in the calculation in Table 5, which assumes a silicon-germanium APD. We find that at least 500 nW optical input power per tap is used to achieve good performance in our MNIST task (FIGS. 4A-4C), ultimately giving sₜₐₚ=0.0078 when neglecting electrical input-referred noise and sₜₐₚ=0.012 when including this noise contribution (full code at Zenodo link). We can exceed this minimum criterion to ensure roughly 1 μW gets to each photodetector, giving sₜₐₚ=0.005 before and 0.007 after including electrical input-referred noise.

### Optimized Tap Coupling Ratio Design

Since light can be lost as it propagates through the photonic mesh (in addition to being “tapped”), it is important to determine the conditions that assure that on average each tap photodiode measures an average amount of light pt ensuring high SNR as previously discussed. In pursuit of this goal, Table 6 shows some reasonable assumptions for various parameters in our calculation. For scalability, we use a rectangular photonic mesh, which is inherently loss-balanced. For our gradient update, placing monitor taps at every waveguide segment preserves this loss balance. There are a total of C=2N phase shift (and 50/50 splitter) columns in a rectangular mesh (given N MZI columns) as shown in Table 6.

First, we evidently need a tap of coupling strength ξ=pₜN/P at the first column. Define ξ_{c} to be the coupling strength at column c so ξ₁=ξ and P_{c} to be the power arriving at column c. Then, the goal is to measure roughly the same amount of light pₜ after each phase shifter in succeeding columns c>1. To determine the coupling strength ξ_{c}, we define the recursive formula:

$${P}_{c} = 1 {0}^{α / 20} ( 1 - {ξ}_{c - 1} ) {P}_{c - 1} \qquad ( 18 )$$

$${ξ}_{c} = {p}_{t} N / {P}_{c} = ξ P / {P}_{c} = ξ 1 {0}^{- cα / 20} {\prod }_{k = 1}^{c - 1} {( 1 - {ξ}_{k} )}^{- 1}$$

This formula generates the coupling ratios ξ_{c} to measure pₜ power on average at every tap in the photonic mesh in the presence of balanced photonic loss. The analysis is shown in FIG. 10F for N=64 and pₜ=1 μW or pₜ/P=0.001=30 dB, which requires C=2N=128 columns given loss per MZI α=0.1, 0.2 or loss per column of α_{c}=α/2=0.05, 0.1.

### Outcome

The total per-mesh training energy consumption (assuming batch size of M and averaging photocurrents over N inputs) is evaluated across all of the various computational steps explored in the optimized circuit in FIGS. 10A-10F (demonstrated logic in FIGS. 11A-11D) using the analysis outlined in FIG. 12A-B and Tables 2 and 3. The results, shown in FIG. 12D show that in situ backpropagation is competitive and outperforms electronic equivalents assuming a per-OP energy of 100 fJ in an all-digital electronic implementation. We find that starting at N=64, we can start to see a significant advantage (2×) at minibatch sizes typical of machine learning protocols (roughly M>16, FIGS. 12A-12D).

FIGS. 13A-13H illustrate low-loss distributed nonlinearity all-analog PNN. FIG. 13A shows a two-layer, low-loss all-analog PNN for inference which uses a low-loss electro-optic (EO) nonlinearity. Compared to previous implementations, loss is linear rather than exponential in the number of photonic network layers (since light is split equally into all photonic layers), improving scalability dramatically. FIG. 13B illustrates how in situ backpropagation is enabled using a switching architecture between each layer that switches between our hybrid or “debug mode” architecture and all-analog and gives us the option to measure forward-going and backward-going signals for each layer. The following configurations are enabled by our architecture (0 and π labels indicate values for nearby switch phases): FIG. 13C is a schematic diagram showing detect previous layer FIG. 13D EO activation (send to next layer or detect to calibrate). FIG. 13E is a schematic diagram showing debug nonlinearity by directly changing the voltage applied to the ring modulator. FIG. 13F is a schematic diagram showing measure backward signal coming from the next layer back into the previous layer. FIG. 13G is a schematic diagram showing calibrate the input into the current layer without the nonlinearity. FIG. 13H is a more complete comparison of the lossy propagation of typical all-analog PNNs versus low-loss distributed PNNs (ours).

Possibility of all-Analog Inference

All-analog inference has been previously proposed because it avoids the conversion to digital and back to analog in intermediate (hidden) NN layers (by far the majority of energy consumption in our technique); this idea was recently proven to be more energy-efficient using a ring-based modulation scheme. We have devised a more scalable and modular “distributed” all-analog architecture compatible with our technique and sufficiently low loss. (All previous proposals to our knowledge involve propagating input light through all optical layers in sequence). This is accomplished using the architecture shown in FIG. 13A, 13H, which uses previously proposed EO nonlinearities and distributes input light to each linear optical element equally.

A key aspect of our approach is the use of integrated MZI switches that switch between various configurations (FIG. 13B-13G) by setting the red or blue electrical switch settings and optical switches 1 and 2 (modulated by phases θ₁, θ₂ respectively switching between bar and cross state). Based on these configurations, we assume that we can calibrate a compact model for any given EO nonlinearity configuration of choice, enabling both efficient all-optical operation and any hybrid operation needed to compute the gradients for efficient backpropagation training. Note that the energy consumption of this architecture due to optical power scales linearly with the number of layers (assuming constant component losses), but this is better than the potential exponential scaling required for the lossy EO nonlinearity when close to the limit of photodiode sensitivity given practical photonic component losses. More quantitatively, let's say that per-MZI loss is α=0.2 dB; then the total loss in the lossy configuration at the final layer would be 0.2 NL dB where as in the low-loss configuration it would be 0.2N+10 log₁₀ L dB, resulting in significant optical input energy savings at the limit of photodiode sensitivity. For N=64, L=10, this loss comes out to 128 dB for the lossy configuration (i.e., previous implementations are infeasible) and 22.8 dB for the low-loss distributed configuration, which is also compatible with in situ backpropagation (i.e., our implementation is both more flexible and lower loss).

1. A all-analog optical neural network comprising:
(a) multiple all-analog optical neural network layers;
(b) a laser and splitter configured to distribute light signals from the laser equally across all of the multiple all-analog optical neural network layers;
(c) integrated MZI switches configured to switch the all-analog optical neural network to a hybrid backpropagation training configuration that measures the light signals in forward and backward directions, and a trains a linear portion of the all-analog optical neural network.

2. The apparatus of claim 1 wherein each of the all-analog optical neural networks comprises:
(a) an integrated silicon photonic neural network (PNN) of Mach-Zehnder interferometers (MZIs) and programmable phase shifters (q) configured to implement a programmable unitary matrix-vector multiplication (MVM) operation U;
(b) a first photonic mesh configured to send an input forward inference signal to the PNN and to measure an output backward adjoint signal from the PNN;
(c) a second photonic mesh configured to measure an output forward inference signal from the PNN and to send an input backward adjoint signal to the PNN;
wherein the forward inference signal propagates forward through the PNN and backward adjoint signal propagates backward through the PNN; and wherein the first photonic mesh and the second photonic mesh are configured to implement both amplitude and phase detection.

3. A hybrid optical-electronic neural network circuit comprising:
(a) a digital circuit configured to implement a nonlinear activation function;
(b) an integrated silicon photonic neural network (PNN) of Mach-Zehnder interferometers (MZIs) and programmable phase shifters (q) configured to implement a programmable unitary matrix-vector multiplication (MVM) operation U;
(c) a first photonic mesh configured to send an input forward inference signal to the PNN and to measure an output backward adjoint signal from the PNN;
(d) a second photonic mesh configured to measure an output forward inference signal from the PNN and to send an input backward adjoint signal to the PNN;
(e) wherein the forward inference signal propagates forward through the PNN and backward adjoint signal propagates backward through the PNN;
(f) wherein the first photonic mesh and the second photonic mesh are configured to implement both amplitude and phase detection;
(g) one or more lasers configured to send the forward inference signal forward through the PNN and to send the backward adjoint signal backward through the PNN;
(h) control circuitry configured to generate the forward inference signal, backward adjoint signal, a sum of forward inference and backward adjoint measurements, and produce a PNN gradient update signal to update the programmable phase shifters of the PNN.

4. The apparatus of claim 3 wherein the control circuitry comprises timed switches, sample-and-hold circuits and amplifiers, and is configured to implement the backpropagation on batches of training data by subtracting in the electronic domain a difference of forward and adjoint signals from a sum of forward and adjoint signals.
